(19) United States
(12) Patent Application Publication
(10) Pub. No.: US 2025/0273376 A1
(43) Pub. Date: Aug. 28, 2025

(54) INDUCTOR COMPONENT

(71) Applicant: Murata Manufacturing Co., Ltd., Kyoto-fu (JP)

(72) Inventors: Yoshimasa YOSHIOKA, Nagaokakyo-shi (JP); Tsuyoshi TAKAMATSU, Nagaokakyo-shi (JP); Hideki KAMO, Nagaokakyo-shi (JP); Kenji TOYOSHIMA, Nagaokakyo-shi (JP)

(73) Assignee: Murata Manufacturing Co., Ltd., Kyoto-fu (JP)

(21) Appl. No.: 19/194,282

(22) Filed: Apr. 30, 2025

Related U.S. Application Data
(63) Continuation of application No. PCT/JP2023/030176, filed on Aug. 22, 2023.

(30) Foreign Application Priority Data
Nov. 2, 2022 (JP) 2022-176446

(51) Int. Cl. H01F 17/00; H01F 27/29

(52) U.S. Cl. CPC H01F 17/0013; H01F 27/292; H01F 2017/002

(57) ABSTRACT

An inductor component includes an element body having first and second principal surfaces opposite to each other; a coil that is in the element body and is wound in a spiral shape along an axis; and first and second external electrodes that are on the element body and are electrically connected to the coil. The axis of the coil is parallel to the first principal surface. The coil includes first coil wirings which are on the first principal surface side with respect to the axis and arranged along the axis on a plane parallel to the first principal surface, second coil wirings which are on the second principal surface side with respect to the axis and arranged along the axis on a plane parallel to the second principal surface, and first and second penetration wirings which extend from the respective first coil wirings toward the respective second coil wirings.

### CROSS-REFERENCE TO RELATED APPLICATION

This application claims benefit of priority to International Patent Application No. PCT/JP2023/030176, filed Aug. 22, 2023, and to Japanese Patent Application 2022-176446, filed Nov. 2, 2022, the entire contents of each are incorporated herein by reference.

### BACKGROUND

The present disclosure relates to an inductor component.

### TECHNICAL FIELD

The present disclosure relates to an inductor component.

### BACKGROUND ART

Conventionally, as an inductor component, there is an inductor component described in Japanese Patent No. 6652280. The inductor component includes an element body, a coil that is provided in the element body and is wound along an axial direction, and a first external electrode and a second external electrode that are provided on the element body and are electrically connected to the coil.

The coil has a plurality of coil patterns layered along an axis. The coil patterns adjacent to each other in the axial direction are connected via a conductive via. Each coil pattern includes a wiring portion extending in a direction orthogonal to the axis and a pad portion that is provided at an end portion of the wiring portion and is connected to the conductive via. A width of the pad portion is wider than a width of the wiring portion in order to improve the connectivity between the pad portion and the conductive via.

### SUMMARY

Incidentally, in the conventional inductor component, since the width of the pad portion is wider than the width of the wiring portion, a part of the pad portion is positioned on an inner side in a radial direction of the coil with respect to the wiring portion. Therefore, an inner diameter of the coil becomes small, and the efficiency of acquisition of inductance is not necessarily high.

In this regard, the present disclosure provides an inductor component capable of increasing the efficiency of acquisition of inductance.

Accordingly, one aspect of the present disclosure provides an inductor component comprising an element body having a first principal surface and a second principal surface opposite to each other; a coil that is provided in the element body and is wound in a spiral shape along an axis; and a first external electrode and a second external electrode that are provided on the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface, a plurality of second coil wirings which are provided on the second principal surface side with respect to the axis and are arranged along the axis on a plane parallel to the second principal surface, a plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order. At least one of two both-end first coil wirings positioned at both ends in the axial direction of the plurality of first coil wirings and two both-end second coil wirings positioned at both ends in the axial direction of the plurality of second coil wirings is a wide coil wiring. A maximum width of the wide coil wiring in the axial direction is larger than a maximum width of at least one coil wiring in the axial direction of inner coil wirings excluding the both-end first coil wirings and the both-end second coil wirings of the plurality of first coil wirings and the plurality of second coil wirings.

Here, the axis indicates an intersection line of a first plane passing through centers between the first coil wirings and the second coil wirings and a second plane passing through centers between the first penetration wirings and the second penetration wirings. The maximum width of the wide coil wiring in the axial direction indicates a maximum value of a width of the wide coil wiring in the axial direction when viewed in a direction orthogonal to the first principal surface of the element body. The maximum width of at least one coil wiring of the inner coil wirings in the axial direction is similarly defined.

That “the external electrode is provided on the element body” specifically indicates that the external electrode is provided on an outer surface side of the element body. For example, this includes a case where the external electrode is provided immediately on an outer surface of the element body, a case where the external electrode is provided on an outer side of the element body via an additional member on the element body, and a case where the external electrode is provided on the outer surface of the external electrode in a state where a part of the external electrode is embedded in the element body.

According to the aspect, since the coil includes the first coil wirings, the first penetration wirings, the second coil wirings, and the second penetration wirings, and each of the first coil wirings, each of the first penetration wirings, each of the second coil wirings, and each of the second penetration wirings form at least a part of the spiral shape by being connected in this order, it is possible to increase an inner diameter of the coil such that it is possible to increase the efficiency of acquisition of inductance. In addition, a Q value can be increased by increasing the efficiency of acquisition of inductance.

Further, when viewed in the direction orthogonal to the first principal surface of the element body, at least some of the wide coil wirings can be disposed in a dead space at both ends of the element body in the axial direction where no coil wiring is present in the related art. As a result, while the dead space of the element body is effectively utilized, it is possible to decrease the electrical resistance of the entire coil compared with that in the related art, and it is possible to increase the Q value of the inductor component.

Preferably, in an embodiment of the inductor component, the maximum width of the wide coil wiring in the axial direction is larger than a maximum width of all the inner coil wirings in the axial direction.

According to the embodiment, it is possible to further decrease the electrical resistance of the entire coil compared with that in the related art, and it is possible to further increase the Q value of the inductor component.

Preferably, in the embodiment of the inductor component, the first external electrode is provided on the first principal surface of the element body, and the wide coil wiring is included only in the plurality of first coil wirings.

According to the embodiment, it is possible to improve connection reliability between the first external electrode and the coil.

Preferably, in the embodiment of the inductor component, the first external electrode is provided on the first principal surface of the element body, and the wide coil wiring is included only in the plurality of second coil wirings.

According to the embodiment, it is possible to increase a distance between the wide coil wiring and the first external electrode as compared with a case where the wide coil wiring is included in the plurality of first coil wirings. Therefore, it is possible to decrease parasitic capacitance between the wide coil wiring and the first external electrode, and it is possible to increase the self-resonant frequency (SRF).

Preferably, in the embodiment of the inductor component, a width of the wide coil wiring in the axial direction is not constant in a direction orthogonal to the axial direction.

According to the embodiment, it is possible to effectively utilize the dead space of the element body.

Preferably, in the embodiment of the inductor component, the first external electrode has a via part connected to the coil, the via part is connected to the wide coil wiring, and an area of a contact surface of the wide coil wiring with the via part is larger than an area of a contact surface of at least one coil wiring of the inner coil wirings with the corresponding first penetration wiring.

According to the embodiment, it is possible to improve connection strength between the first external electrode and the wide coil wiring.

Preferably, in the embodiment of the inductor component, the first external electrode has a plurality of via parts connected to the coil, and the plurality of via parts are connected to the wide coil wiring.

According to the embodiment, since the plurality of via parts are connected to the wide coil wiring, it is possible to improve the connection strength between the first external electrode and the wide coil wiring as compared with a case where a single via part is connected thereto.

Preferably, in the embodiment of the inductor component, a thickness of the wide coil wiring is smaller than a thickness of at least one coil wiring of the inner coil wirings.

Since the wide coil wiring has a relatively large maximum width in the axial direction, it is possible to reduce an increase in electrical resistance even if the thickness is decreased. Therefore, according to the embodiment, it is possible to decrease the electrical resistance of the entire coil compared with that in the related art, and it is possible to realize a thin inductor component.

Preferably, in the embodiment of the inductor component, the wide coil wiring is included in only one group of a first group including the plurality of first coil wirings and a second group including the plurality of second coil wirings, and a thickness of all the coil wirings in the group including the wide coil wiring from the first group and the second group is smaller than a thickness of all the coil wirings in the group without including the wide coil wiring.

According to the embodiment, it is possible to realize a thinner inductor component.

Preferably, in the embodiment of the inductor component, either the plurality of first coil wirings or the plurality of second coil wirings include only the wide coil wirings.

According to the embodiment, it is possible to decrease the electrical resistance of the entire coil compared with that in the related art.

Preferably, in the embodiment of the inductor component, when viewed in a direction orthogonal to the first principal surface, a ratio of a total area of the plurality of first coil wirings to an area of the first principal surface is 50% or more and 95% or less (i.e., from 50% to 95%), and a ratio of a total area of the plurality of second coil wirings to the area of the first principal surface is 50% or more and 95% or less (i.e., from 50% to 95%).

According to the embodiment, by setting the ratio of the total area of the plurality of first coil wirings to the area of the first principal surface to 50% or more, it is possible to reduce leakage of magnetic flux to an outer side of the coil in a radial direction thereof. By setting the ratio of the total area of the plurality of first coil wirings to the area of the first principal surface to 95% or less, it is possible to easily perform division into individual inductor components. Similarly, by setting the ratio of the total area of the plurality of second coil wirings to the area of the first principal surface to 50% or more, it is possible to reduce leakage of magnetic flux to the outer side of the coil in the radial direction thereof. By setting the ratio of the total area of the plurality of second coil wirings to the area of the first principal surface to 95% or less, it is possible to easily perform division into individual inductor components.

Preferably, in the embodiment of the inductor component, the wide coil wiring is included in at least one group of a first group including the plurality of first coil wirings and a second group including the plurality of second coil wirings, and when viewed in a direction orthogonal to the first principal surface, a ratio of a total area of all the coil wirings in a group including the wide coil wiring from the first group and the second group to an area of the first principal surface is 65% or more.

According to the embodiment, it is possible to further reduce leakage of the magnetic flux to the outer side of the coil in the radial direction thereof.

Preferably, in the embodiment of the inductor component, the wide coil wiring is included in only one group of a first group including the plurality of first coil wirings and a second group including the plurality of second coil wirings, and when viewed in a direction orthogonal to the first principal surface, a ratio of a total area of all the coil wirings in a group including the wide coil wiring from the first group and the second group to an area of the first principal surface is higher than a ratio of a total area of all the coil wirings in a group without including the wide coil wiring to the area of the first principal surface.

According to the embodiment, it is possible to increase the ratio of all the coil wirings in the group including the wide coil wiring while the number of turns of the coil is secured.

Preferably, in the embodiment of the inductor component, the wide coil wiring is included in both of the plurality of first coil wirings and the plurality of second coil wirings.

According to the embodiment, it is possible to further decrease the electrical resistance of the entire coil compared with that in the related art.

Preferably, in the embodiment of the inductor component, when viewed in a direction orthogonal to the first principal surface, the wide coil wiring has a corner portion on an outer side of the coil in a radial direction, that is, on a center side of the element body in the axial direction, and the wide coil wiring is connected to one of the first penetration wirings at the corner portion.

According to the embodiment, since it is possible to shorten a coil length, it is possible to increase the Q value.

Preferably, in the embodiment of the inductor component, when viewed in a direction orthogonal to the first principal surface, an external shape of the wide coil wiring includes a part conforming to an external shape of the element body, and a part of the first coil wirings and the second coil wirings which conforms to an external shape of a coil wiring adjacent to the wide coil wiring in the axial direction on the same plane.

According to the embodiment, it is possible to dispose the wide coil wiring with a minimum gap from the element body, in the dead space that can be formed between the external shape of the element body and the external shape of the coil wiring adjacent to the wide coil wiring, of the first coil wiring and the second coil wiring, in the axial direction on the same plane, when viewed in the direction orthogonal to the first principal surface. Therefore, since it is possible to more effectively utilize the dead space of the element body, it is possible to further increase the maximum width of the wide coil wiring in the axial direction. As a result, it is possible to further decrease the electrical resistance of the entire coil compared with that in the related art, and it is possible to further increase the Q value of the inductor component.

Preferably, in the embodiment of the inductor component, the wide coil wiring is connected to one of the first penetration wirings, and an area of a contact surface of the wide coil wiring with the corresponding first penetration wiring is larger than an area of a contact surface of at least one coil wiring of the inner coil wirings with the corresponding first penetration wiring.

According to the embodiment, it is possible to further decrease the electrical resistance of the first penetration wiring connected to the wide coil wiring than the electrical resistance of the other first penetration wirings. As a result, it is possible to decrease the electrical resistance of the entire coil compared with that in the related art.

Preferably, in the embodiment of the inductor component, a first end surface of the first penetration wiring in an extending direction is connected to one of the corresponding first coil wiring and the corresponding second coil wiring, a second end surface of the first penetration wiring in the extending direction is connected to the other of the corresponding first coil wiring and the corresponding second coil wiring, the wide coil wiring is connected to at least the first end surface, of the first end surface and the second end surface, and an area of the first end surface is larger than an area of the second end surface.

According to the embodiment, it is possible to further decrease the electrical resistance of the first penetration wiring connected to the wide coil wiring than the electrical resistance of the other first penetration wirings. As a result, it is possible to decrease the electrical resistance of the entire coil compared with that in the related art.

According to the inductor component which is the one aspect of the present disclosure, it is possible to increase the efficiency of acquisition of inductance.

### BRIEF DESCRIPTION OF THE DRAWINGS

FIG. 1 is a schematic bottom view of an inductor component from a bottom surface side according to a first embodiment;

FIG. 2 is a cross-sectional view taken along line II-II in FIG. 1;

FIG. 3 is a cross-sectional view taken along line III-III in FIG. 1;

FIG. 4 is an enlarged view of a part of FIG. 1;

FIG. 5A is a schematic cross-sectional view illustrating a method for manufacturing an inductor component;

FIG. 5B is a schematic cross-sectional view illustrating the method for manufacturing an inductor component;

FIG. 5C is a schematic cross-sectional view illustrating the method for manufacturing an inductor component;

FIG. 5D is a schematic cross-sectional view for illustrating the method for manufacturing an inductor component;

FIG. 5E is a schematic cross-sectional view illustrating the method for manufacturing an inductor component;

FIG. 5F is a schematic cross-sectional view illustrating the method for manufacturing an inductor component;

FIG. 5G is a schematic cross-sectional view illustrating the method for manufacturing an inductor component;

FIG. 5H is a schematic cross-sectional view illustrating the method for manufacturing an inductor component;

FIG. 5I is a schematic cross-sectional view illustrating the method for manufacturing an inductor component;

FIG. 5J is a schematic cross-sectional view illustrating the method for manufacturing an inductor component;

FIG. 5K is a schematic cross-sectional view illustrating the method for manufacturing an inductor component;

FIG. 5L is a schematic cross-sectional view illustrating the method for manufacturing an inductor component;

FIG. 5M is a schematic cross-sectional view illustrating the method for manufacturing an inductor component;

FIG. 6A is a cross-sectional view showing a first modification example of the inductor component;

FIG. 6B is a cross-sectional view showing a second modification example of the inductor component;

FIG. 6C is a cross-sectional view showing a third modification example of the inductor component;

FIG. 6D is a cross-sectional view showing a fourth modification example of the inductor component;

FIG. 7 is a schematic bottom view of an inductor component from a bottom surface side according to a second embodiment;

FIG. 8 is a schematic bottom view of an inductor component from a bottom surface side according to a third embodiment;

FIG. 9 is a cross-sectional view taken along line IX-IX in FIG. 8;

FIG. 10 is a schematic bottom view of an inductor component from a bottom surface side according to a fourth embodiment;

FIG. 11 is a schematic bottom view of an inductor component from a bottom surface side according to a fifth embodiment;

FIG. 12 is a cross-sectional view taken along line XII-XII in FIG. 11;

FIG. 13 is a schematic bottom view of an inductor component from a bottom surface side according to a sixth embodiment;

FIG. 14 is a cross-sectional view taken along line XIV-XIV in FIG. 13;

FIG. 15 is an enlarged view of a part of FIG. 13;

FIG. 16A is a schematic cross-sectional view illustrating a method for manufacturing the inductor component;

FIG. 16B is a schematic cross-sectional view illustrating the method for manufacturing an inductor component;

FIG. 16C is a schematic cross-sectional view illustrating the method for manufacturing an inductor component;

FIG. 16D is a schematic cross-sectional view illustrating the method for manufacturing an inductor component;

FIG. 16E is a schematic cross-sectional view illustrating the method for manufacturing an inductor component;

FIG. 16F is a schematic cross-sectional view illustrating the method for manufacturing an inductor component;

FIG. 16G is a schematic cross-sectional view illustrating the method for manufacturing an inductor component;

FIG. 16H is a schematic cross-sectional view illustrating the method for manufacturing an inductor component;

FIG. 17A is a cross-sectional view showing a first modification example of the inductor component;

FIG. 17B is a cross-sectional view showing a second modification example of the inductor component; and

FIG. 17C is a cross-sectional view showing a third modification example of the inductor component.

### DETAILED DESCRIPTION

Hereinafter, an inductor component which is the one aspect of the present disclosure will be described in detail with reference to embodiments shown in the drawings. Note that the drawings include some schematic drawings, and may not reflect actual dimensions and ratios.

### First Embodiment

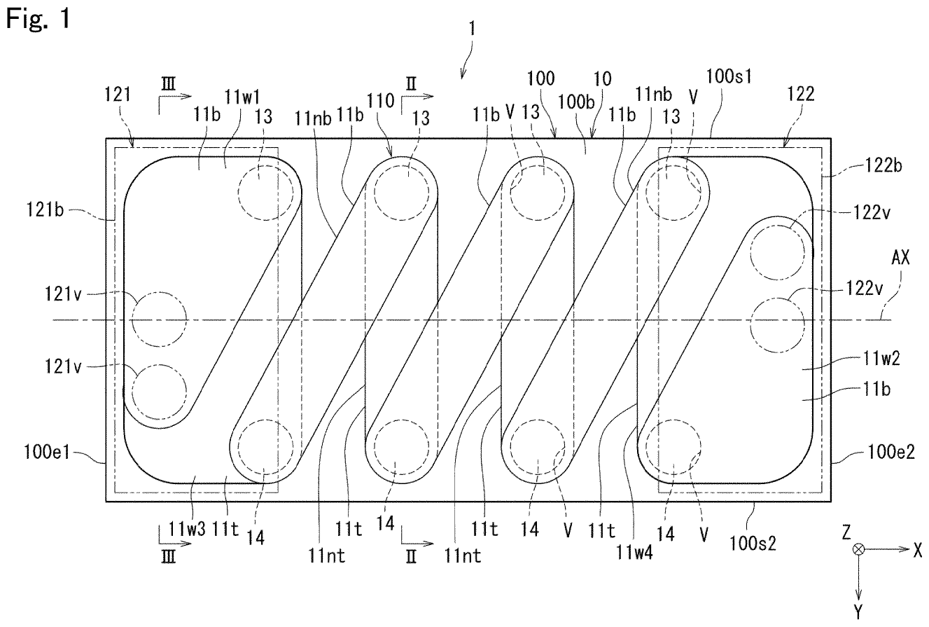

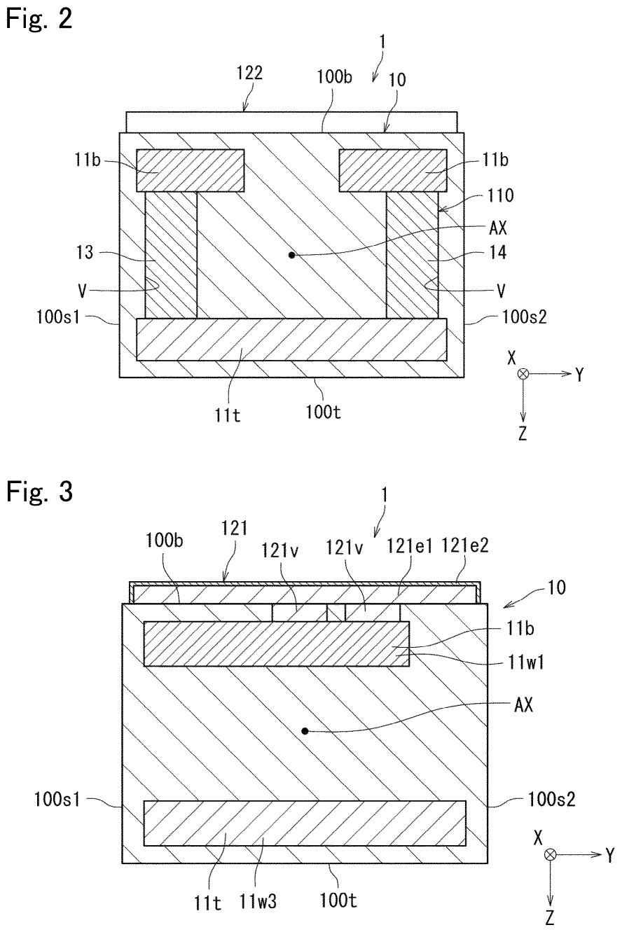

An inductor component 1 according to the first embodiment will be described below. FIG. 1 shows a schematic bottom view of the inductor component 1 from a bottom surface side thereof. FIG. 2 is a cross-sectional view taken along line II-II in FIG. 1. FIG. 3 is a cross-sectional view taken along line III-III in FIG. 1. Note that, in FIG. 1, an external electrode is drawn by a two-dot chain line for convenience. In addition, in FIG. 1, an element body 10 is drawn transparently so that a structure thereof can be easily understood, but may be translucent or opaque.

### 1. General Configuration

A general configuration of the inductor component 1 will be described. The inductor component 1 is, for example, a surface mount inductor component that is used in a high-frequency signal transmission circuit. As shown in FIGS. 1, 2, and 3, the inductor component 1 includes the element body 10, a coil 110 that is provided in the element body 10 and is wound in a spiral shape along an axis AX, and a first external electrode 121 and a second external electrode 122 that are provided on the element body 10 and are electrically connected to the coil 110.

The element body 10 has a length, a width, and a height. The element body 10 has a first end surface 100e1 and a second end surface 100e2 on both end sides in a length direction, a first side surface 100s1 and a second side surface 100s2 on both end sides in a width direction, and a bottom surface 100b and a top surface 100t on both end sides in a height direction. That is, outer surfaces 100 of the element body 10 include the first end surface 100e1 and the second end surface 100e2, the first side surface 100s1 and the second side surface 100s2, and the bottom surface 100b and the top surface 100t. The bottom surface 100b corresponds to an example of a “first principal surface” described in CLAIMS, and the top surface 100t corresponds to an example of a “second principal surface” described in CLAIMS.

As shown in the drawings, hereinafter, for convenience of description, a direction that is the length direction (longitudinal direction) of the element body 10 and is from the first end surface 100e1 toward the second end surface 100e2 is referred to as an X direction. In addition, a direction that is the width direction of the element body 10 and is from the first side surface 100s1 toward the second side surface 100s2 is referred to as a Y direction. In addition, a direction that is the height direction of the element body 10 and is from the bottom surface 100b toward the top surface 100t is referred to as a Z direction. The X direction, the Y direction, and the Z direction are directions orthogonal to each other and form a right-handed system when arranged in an order of X, Y, and Z.

In this specification, the “outer surfaces 100 of the element body” including the first end surface 100e1, the second end surface 100e2, the first side surface 100s1, the second side surface 100s2, the bottom surface 100b, and the top surface 100t of the element body 10 do not simply mean surfaces of the element body 10 toward the outer circumferential sides of the element body 10, but are surfaces serving as a boundary between an outside and an inside of the element body 10. In addition, “above the outer surfaces 100 of the element body 10” does not indicate an absolute direction such as a vertical upward direction defined in the direction of gravity, but indicates a direction toward the outside with the outer surfaces 100 as a reference, of the outside and inside with the outer surfaces 100 as the boundary therebetween. Hence, “above the outer surfaces 100” indicates a relative direction determined depending on an orientation of the outer surfaces 100. In addition, “above” with respect to a certain element means not only above from the corresponding element, that is, an upper position via another object on the corresponding element or an upper position apart from the corresponding element at an interval, but also a position immediately on the corresponding element to be in contact with the corresponding element.

The axis AX of the coil 110 is disposed parallel to the bottom surface 100b. The coil 110 includes a plurality of bottom surface wirings 11b which are provided on the bottom surface 100b side with respect to the axis AX and are arranged along the axis AX on a plane parallel to the bottom surface 100b, a plurality of top surface wirings 11t which are provided on the top surface 100t side with respect to the axis AX and are arranged along the axis AX on a plane parallel to the top surface 100t, a plurality of first penetration wirings 13 which extend from the respective bottom surface wirings 11b toward the respective top surface wirings 11t, and are arranged along the axis AX, and a plurality of second penetration wirings 14 which extend from the respective bottom surface wirings 11b toward the respective top surface wirings 11t, are provided on a side opposite to the respective first penetration wirings 13 with respect to the axis AX, and are arranged along the axis AX. Each of the bottom surface wirings 11b, each of the first penetration wirings 13, each of the top surface wirings 11t, and each of the second penetration wirings 14 form at least a part of a spiral shape by being connected in this order.

The bottom surface wiring 11b corresponds to an example of a “first coil wiring” described in CLAIMS, and the top surface wiring 11t corresponds to an example of a “second coil wiring” described in CLAIMS. The axis AX indicates an intersection line of a first plane passing through centers between the bottom surface wirings 11b and the top surface wirings 11t and a second plane passing through centers between the first penetration wirings 13 and the second penetration wirings 14. That is, the axis AX is a straight line passing through a center of an inner diameter portion of the coil 110. The axis AX of the coil 110 does not have a dimension in a direction orthogonal to the axis AX.

According to the configuration described above, since the coil 110 includes the bottom surface wirings 11b, the first penetration wirings 13, the top surface wirings 11t, and the second penetration wirings 14, and each of the bottom surface wirings 11b, each of the first penetration wirings 13, each of the top surface wirings 11t, and each of the second penetration wirings 14 form at least a part of the spiral shape by being connected in this order, it is possible to increase an inner diameter of the coil 110 such that it is possible to increase the efficiency of acquisition of inductance. In addition, a Q value can be increased by increasing the efficiency of acquisition of inductance.

To be more specific, since pad portions of a conventional inductor component or the bottom surface wirings 11b and the top surface wirings 11t of the present embodiment are “reception portions” of wirings (conductive vias of the conventional inductor component or the first penetration wirings 13 and the second penetration wirings 14 of the present embodiment) which penetrate an element body, the pad portions and the bottom and top surface wirings have a shape expanding perpendicularly to a direction in which to penetrate the element body. Here, in a configuration of the conventional inductor component, since the conductive vias extend in a direction parallel to an axis of a coil, the pad portions are expanded in a direction perpendicular to the axis of the coil and are likely to have a structure in which magnetic flux generated in an axial direction of the coil is blocked.

On the other hand, in the present embodiment, since the first penetration wiring 13 and the second penetration wiring 14 extend in a direction perpendicular to the axis AX of the coil 110, the bottom surface wiring 11b and the top surface wiring 11t are expanded in a direction parallel to the axis AX of the coil 110. Accordingly, it is difficult for the bottom surface wiring 11b and the top surface wiring 11t to have a structure in which magnetic flux generated in an axis AX direction is blocked. That is, according to the present embodiment, it is possible to have the structure in which it is difficult to block the magnetic flux such that it is possible to improve the efficiency of acquisition of inductance and the Q value.

At least one of the two bottom surface wirings 11b positioned at both ends in the axis AX direction, of the plurality of bottom surface wirings 11b, and the two top surface wirings 11t positioned at both ends in the axis AX direction, of the plurality of top surface wirings 11t, is a wide coil wiring. The two bottom surface wirings 11b at both ends correspond to an example of “both-end first coil wirings” described in CLAIMS and are referred to as both-end bottom surface wirings 11b. The two top surface wirings 11t at both ends correspond to an example of “both-end second coil wirings” described in CLAIMS and are also referred to as both-end top surface wirings 11t. In this embodiment, the two bottom surface wirings 11b positioned at both ends in the axis AX direction, of the plurality of bottom surface wirings 11b, and the two top surface wirings 11t positioned at both ends in the axis AX direction, of the plurality of top surface wirings 11t, are all the wide coil wirings.

Hereinafter, the wide coil wiring positioned closest to the first end surface 100e1, of the plurality of bottom surface wirings 11b, will be referred to as a “first wide coil wiring W1”, the wide coil wiring positioned closest to the second end surface 100e2, of the plurality of bottom surface wirings 11b, will be referred to as a “second wide coil wiring W2”, the wide coil wiring positioned closest to the first end surface 100e1, of the plurality of top surface wirings 11t will be referred to as a “third wide coil wiring W3”, and the wide coil wiring positioned closest to the second end surface 100e2, of the plurality of top surface wirings 11t, will be referred to as a “fourth wide coil wiring W4”. In addition, of the plurality of bottom surface wirings 11b, the coil wirings other than the two bottom surface wirings 11b (the both end bottom surface wirings 11b) positioned at both ends in the axis AX direction are referred to as “narrow bottom surface wirings 11nb”, and of the plurality of top surface wirings 11t, the coil wirings other than the two top surface wirings 11t (the both-end top surface wirings 11t) positioned at both ends in the axis AX direction are referred to as “narrow top surface wirings 11nt”. The narrow bottom surface wirings 11nb and the narrow top surface wirings 11nt correspond to an example of “inner coil wirings” described in CLAIMS.

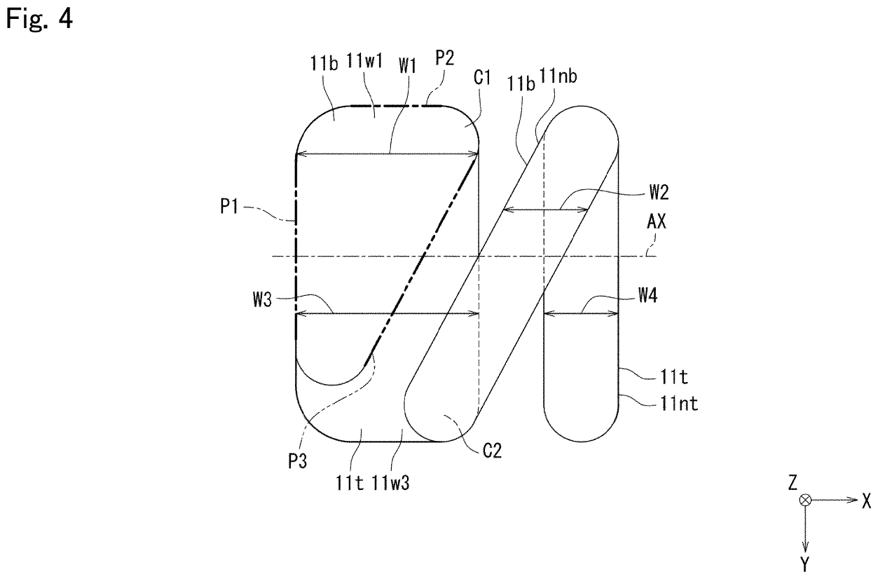

FIG. 4 is an enlarged view of a part of FIG. 1. To be more specific, FIG. 4 is an enlarged view of a first wide coil wiring 11w1, a narrow bottom surface wiring 11nb adjacent to the first wide coil wiring 11w1 in the axis AX direction, a third wide coil wiring 11w3, and a narrow top surface wiring 11nt adjacent to the third wide coil wiring 11w3 in the axis AX direction.

As shown in FIG. 4, a maximum width W1 of the first wide coil wiring 11w1 in the axis AX direction is larger than a maximum width of at least one of the narrow bottom surface wiring 11nb and the narrow top surface wiring 11nt in the axis AX direction. A maximum width W3 of the third wide coil wiring 11w3 in the axis AX direction is larger than a maximum width of at least one of the narrow bottom surface wiring 1nb and the narrow top surface wiring 11nt in the axis AX direction.

The maximum width W1 of the first wide coil wiring 11w1 in the axis AX direction indicates a maximum value of a width of the first wide coil wiring 11w1 in the axis AX direction when viewed in a direction (Z direction) orthogonal to the bottom surface 100b. The maximum width W3 of the third wide coil wiring 11w3 is defined in the same manner.

In this embodiment, a shape of the first wide coil wiring 11w1 is substantially a triangular shape in which the width in the axis AX direction increases from the second side surface 100s2 side toward the first side surface s1 side when viewed in the Z direction. To be more specific, when viewed in the Z direction, the shape of the first wide coil wiring 11w1 is substantially a triangular shape having three sides including one side parallel to the X direction, one side parallel to the Y direction, and one side parallel to the extending direction of the narrow bottom surface wiring 11nb adjacent to the first wide coil wiring in the axis AX direction.

The maximum width W1 of the first wide coil wiring 11w1 in the axis AX direction is larger than the maximum width W2 of the narrow bottom surface wiring 1nb in the axis AX direction. The maximum width W1 of the first wide coil wiring 11w1 in the axis AX direction is larger than the maximum width W4 of the narrow top surface wiring 11nt in the axis AX direction. Note that the maximum width W1 may be larger than any one of the maximum width W2 and the maximum width W4.

A shape of the third wide coil wiring 11w3 is substantially a rectangular shape extending in the Y direction when viewed in the Z direction. To be more specific, the shape of the third wide coil wiring 11w3 is substantially the rectangular shape having four sides including two sides parallel to the X direction and two sides parallel to the Y direction when viewed in the Z direction.

The maximum width W3 of the third wide coil wiring 11w3 in the axis AX direction is larger than the maximum width W2 of the narrow bottom surface wiring 11nb in the axis AX direction. The maximum width W3 of the third wide coil wiring 11w3 in the axis AX direction is larger than the maximum width W4 of the narrow top surface wiring 11nt in the axis AX direction. The maximum width W2 and the maximum width W4 are defined in the same manner as the maximum width W1. Note that the maximum width W3 may be larger than any one of the maximum width W2 and the maximum width W4.

Note that, although the maximum widths of the first wide coil wiring W1 and the third wide coil wiring W3 have been described, the same applies to the maximum widths of the second wide coil wiring W2 and the fourth wide coil wiring W4. That is, the maximum width of the second wide coil wiring 11w2 in the axis AX direction is larger than the maximum width of at least one of the narrow bottom surface wiring 11nb and the narrow top surface wiring 11nt in the axis AX direction. The maximum width of the fourth wide coil wiring 11w4 in the axis AX direction is larger than the maximum width of at least one of the narrow bottom surface wiring 11nb and the narrow top surface wiring 11nt in the axis AX direction.

According to the configuration described above, when viewed in the direction orthogonal to the bottom surface 100b, at least some of the first to fourth wide coil wirings 11w1 to 11w4 can be disposed in a dead space at both ends of the element body 10 in the axis AX direction where no coil wiring is present in the related art. As a result, while the dead space of the element body 10 is effectively utilized, it is possible to decrease the electrical resistance of the entire coil 110 compared with that in the related art, and it is possible to increase the Q value of the inductor component 1.

To be more specific, in FIG. 1, for example, in a case where the bottom surface wiring 11b positioned closest to the first end surface 100e1 is not the wide coil wiring but the coil wiring which extends linearly in a direction parallel to the narrow bottom surface wiring 11nb adjacent thereto in the axis AX direction and has the same wiring width as that of the narrow bottom surface wiring 11nb, a dead space in which no bottom surface wiring 11b is present may be formed at a corner portion of the element body 10 at a position where the first end surface 100e1 and the first side surface 100s1 intersect each other. According to the configuration described above, since the maximum width W1 of the first wide coil wiring 11w1 in the axis AX direction is relatively large, a part of the first wide coil wiring 11w1 can be disposed in this dead space. The same applies to the second to fourth wide coil wirings 11w2 to 11w4. As a result, while the dead space of the element body 10 is effectively utilized, it is possible to decrease the electrical resistance of the entire coil 110 compared with that in the related art, and it is possible to increase the Q value of the inductor component 1.

### 2. Configurations of Respective Units

### (Inductor Component 1)

A volume of the inductor component 1 is preferably 0.08 mm³ or smaller, and a size of a long side of the inductor component 1 is 0.65 mm or smaller. The size of the long side of the inductor component 1 indicates the largest value of a length, a width, and a height of the inductor component 1, and in this embodiment, indicates the length in the X direction. According to the configuration described above, since the volume of the inductor component 1 is small and the long side of the inductor component 1 is short, a weight of the inductor component 1 is reduced. Therefore, even if the external electrodes 121 and 122 are small, necessary mounting strength can be obtained. In addition, a thickness of the inductor component 1 is preferably 200 μm or smaller. This enables a thin inductor component 1 to be obtained.

To be more specific, the size (length (X direction)×width (Y direction)×height (Z direction)) of the inductor component 1 is 0.6 mm×0.3 mm×0.3 mm, 0.4 mm×0.2 mm×0.2 mm, 0.25 mm×0.125 mm×0.120 mm, or the like. In addition, the width and the height may not be equal, and may be, for example, 0.4 mm×0.2 mm×0.3 mm.

### (Element Body 10)

Preferably, the element body 10 contains SiO₂. This enables insulation properties and stiffness to be imparted to the element body 10. The element body 10 is made of, for example, a glass sintered body. The glass sintered body may contain alumina, and the strength of the element body can be further increased.

The glass sintered body is formed by, for example, layering insulating layers containing a plurality of types of glass. A layering direction of the plurality of insulating layers is the Z direction. That is, the insulating layer has a layer shape having a principal surface expanding on an X-Y plane. Note that, in the element body 10, an interface between the plurality of insulating layers may not be distinct due to firing or the like.

Note that the element body 10 may include, for example, a glass substrate. The glass substrate may be a single-layer glass substrate, and since most of the element body is made of glass, it is possible to reduce a loss such as an eddy current loss at a high frequency.

### (Coil 110)

The coil 110 includes the plurality of bottom surface wirings 11b, the plurality of top surface wirings 11t, the plurality of first penetration wirings 13, and the plurality of second penetration wirings 14. The bottom surface wirings 11b, the first penetration wirings 13, the top surface wirings 11t, and the second penetration wirings 14 are connected in this order, respectively, to constitute at least a part of the coil 110 wound in the axis AX direction.

According to the configuration described above, since the coil 110 is a so-called helical coil 110, in a cross section orthogonal to the axis AX, it is possible to reduce a region where the bottom surface wiring 11b, the top surface wiring 11t, the first penetration wiring 13, and the second penetration wiring 14 are laid out parallel to each other in a winding direction of the coil 110, and it is possible to reduce stray capacitance in the coil 110.

Here, the helical shape indicates a shape in which the number of turns of the entire coil is more than one turn, and the number of turns of the coil in the cross section orthogonal to the axis is less than one turn. One or more turns indicate a state in which the wirings of the coil have, on the cross section orthogonal to the axis, parts that are adjacent to each other in a radial direction and are laid out parallel to each other in the winding direction when viewed in an axial direction, and less than one turn indicates a state in which the wirings of the coil does not have, on the cross section orthogonal to the axis, parts that are adjacent to each other in the radial direction and are laid out parallel to each other in the winding direction when viewed in the axial direction.

The narrow bottom surface wirings 11nb extend only in one direction. To be more specific, the narrow bottom surface wirings 11nb slightly tilts in the X direction and extend in the Y direction. The plurality of narrow bottom surface wirings 11nb are arranged parallel to each other in the X direction. The plurality of narrow bottom surface wirings 11nb may have the same or different maximum widths in the axis AX direction, respectively, and have the same maximum width in this embodiment. Here, in a photolithography process, when deformed illumination such as annular illumination or dipole illumination is used, pattern resolution in a specific direction can be enhanced to form a finer pattern. According to the configuration described above, since the narrow bottom surface wirings 11nb extend only in one direction, it is possible to form the fine narrow bottom surface wirings 11nb and reduce the size of the inductor component 1 by using, for example, modified illumination in the photolithography process.

The narrow top surface wirings 11nt extend only in one direction. To be more specific, the narrow top surface wirings 11nt have a shape extending in the Y direction. The plurality of narrow top surface wirings 11nt are arranged parallel to each other in the X direction. The plurality of narrow top surface wirings 11nt may have the same or different maximum widths in the axis AX direction, respectively, and have the same maximum width in this embodiment. According to the configuration described above, since the narrow top surface wirings 11nt extend only in one direction, it is possible to form the fine narrow top surface wirings 11nt and reduce the size of the inductor component 1 by using, for example, modified illumination in the photolithography process.

The bottom surface wirings 11b and the top surface wirings 11t are made of a good conductor material such as copper, silver, gold, or an alloy thereof. The bottom surface wirings 11b and the top surface wirings 11t may be a metal film formed by plating, vapor deposition, sputtering, or the like, or may be a metal sintered body obtained by applying and sintering a conductor paste. In addition, the bottom surface wirings 11b and the top surface wirings 11t may have a multilayer structure in which a plurality of metal layers are layered. The bottom surface wirings 11b and the top surface wirings 11t have a thickness of preferably 5 μm or more and 50 μm or less (i.e., from 5 μm to 50 μm).

The first penetration wirings 13 are disposed in through-holes V of the element body 10 on the first side surface 100s1 side with respect to the axis AX, and the second penetration wirings 14 are disposed in the other through-holes V of the element body 10 on the second side surface 100s2 side with respect to the axis AX. Each of the first penetration wirings 13 and the second penetration wirings 14 extends in a direction orthogonal to the bottom surface 100b and the top surface 100t. This enables lengths of the first penetration wirings 13 and the second penetration wirings 14 to be shortened, thus enabling the direct current resistance (Rdc) to be reduced. The plurality of first penetration wirings 13 and the plurality of second penetration wirings 14 are all arranged parallel to each other in the X direction.

Preferably, the first penetration wirings 13 contain SiO₂. This enables a linear expansion coefficient of the first penetration wiring 13 to be equal to a linear expansion coefficient of the element body 10 in a case where the element body 10 contains SiO₂, thus enabling cracks between the first penetration wirings 13 and the element body 10 to be reduced. The first penetration wiring 13 is made of, for example, a conductive paste. A conductive material is Ag, Cu, or the like. Similarly, the second penetration wirings 14 preferably contain SiO₂.

Preferably, at least one wiring of the bottom surface wirings 11b, the top surface wirings 11t, the first penetration wirings 13, and the second penetration wirings 14 includes a void portion or a resin portion. This enables stress due to a difference in linear expansion coefficient between the wiring and the element body 10 to be absorbed by the void portion or the resin portion, thus enabling the stress to be alleviated. As a method of forming the void portion, for example, the void portion can be formed by sintering a wiring, by using a member which is burned into the material of the wiring by being sintered. As a method for forming the resin portion, for example, the resin portion can be formed by using a conductive paste in the material of the wiring.

Preferably, at least one wiring of the bottom surface wirings 11b and the top surface wirings 11t contains SiO₂. This enables a linear expansion coefficient of the wiring to be equal to the linear expansion coefficient of the element body 10 in a case where the element body 10 contains SiO₂, thus enabling cracks between the wiring and the element body 10 to be reduced.

Preferably, the first external electrode 121 is provided on the bottom surface 100b of the element body 10, and the wide coil wiring is included only in the plurality of bottom surface wirings 11b. In this case, the wide coil wiring is not included in the plurality of top surface wirings 11t. According to this configuration, it is possible to improve connection reliability between the first external electrode 121 and the coil 110. To be more specific, since the wide coil wiring has a relatively large maximum width in the axis AX direction, a contact area between the first external electrode 121 and the wide coil wiring can be made to be larger compared with that in the related art. In addition, even in a case where misalignment occurs in at least one of the first external electrode 121 and the wide coil wiring, the wide coil wiring can reduce effects of this misalignment, and it is possible to more reliably connect the first external electrode 121 and the wide coil wiring. As a result, it is possible to improve connection reliability between the first external electrode 121 and the coil 110.

Preferably, the wide coil wiring is included in both the plurality of bottom surface wirings 11b and the plurality of top surface wirings 11t. According to this configuration, it is possible to further decrease the electrical resistance of the entire coil 110 compared with that in the related art.

Preferably, the width of the wide coil wiring in the axis AX direction is not constant in a direction orthogonal to the axis AX direction. To be more specific, regarding all the wide coil wirings of the first wide coil wiring 11w1 and the second wide coil wiring 11w2, a width in the axis AX direction at a central region except both end portions thereof in the direction orthogonal to the axis AX direction is not constant in the direction orthogonal to the axis AX direction. According to this configuration, it is possible to effectively utilize the dead space of the element body 10.

Preferably, the maximum widths of the respective wide coil wirings of the first to fourth wide coil wirings 11w1 to 11w4 in the axis AX direction are larger than the maximum widths of all the narrow bottom surface wirings 11nb and all the narrow top surface wirings 11nt in the axis AX direction. According to this configuration, it is possible to further decrease the electrical resistance of the entire coil 110 compared with that in the related art, and it is possible to further increase the Q value of the inductor component 1.

Preferably, as shown in FIGS. 1 and 4, when viewed in the direction orthogonal to the bottom surface 100b, the first wide coil wiring 11w1 has a corner portion C1 on an outer side of the coil 110 in a radial direction thereof, that is, on a center side of the element body 10, and the first wide coil wiring 11w1 is connected to the first penetration wiring 13 at the corner portion C1. According to this configuration, since it is possible to shorten a coil length of the coil 110, it is possible to increase the Q value. The coil length indicates a length of the coil 110 in the axis AX direction.

Similarly, it is preferable that, when viewed in the direction orthogonal to the bottom surface 100b, the fourth wide coil wiring 11w4 has a corner portion on an outer side of the coil 110 in the radial direction thereof, that is, on a center side of the element body 10, and the fourth wide coil wiring 11w4 is connected to the first penetration wiring 13 at the corner portion.

Preferably, when viewed in the direction orthogonal to the bottom surface 100b, the third wide coil wiring 11w3 has a corner portion C2 on an outer side of the coil 110 in the radial direction thereof, that is, on a center side of the element body 10, and the third wide coil wiring 11w3 is connected to the second penetration wiring 14 at the corner portion C2. According to this configuration, since it is possible to shorten a coil length of the coil 110, it is possible to increase the Q value.

Similarly, it is preferable that, when viewed in the direction orthogonal to the bottom surface 100b, the second wide coil wiring 11w2 has a corner portion on an outer side of the coil 110 in the radial direction thereof, that is, on a center side of the element body 10, and the second wide coil wiring 11w2 is connected to the second penetration wiring 14 at the corner portion.

Preferably, when viewed in the direction orthogonal to the bottom surface 100b, an external shape of the first wide coil wiring 11w1 includes a part conforming to an external shape of the element body 10, and a part of the bottom surface wirings 11b and the top surface wirings 11t which conforms to an external shape of a coil wiring adjacent to the first wide coil wiring 11w1 in the axis AX direction on the same plane. To be more specific, as shown in FIGS. 1 and 4, the external shape of the first wide coil wiring 11w1 includes a part P1 conforming to the external shape of the first end surface 100e1 of the element body 10, a part P2 conforming to the external shape of the first side surface 100s1 of the element body 10, and a part P3 conforming to the external shape of the narrow bottom surface wiring 11nb adjacent to the first wide coil wiring 11w1 in the axis AX direction on the same plane. Note that, in FIG. 4, for convenience, the part P1 and the part P2 are drawn by a chain line, and the part P3 is drawn by a two-dot chain line.

According to the configuration described above, it is possible to dispose the first wide coil wiring 11w1 with a minimum gap from the element body 10, in the dead space that can be formed between the external shape of the element body 10 and the external shape of the narrow bottom surface wiring 11nb, when viewed in the direction orthogonal to the bottom surface 100b. Therefore, since it is possible to more effectively utilize the dead space of the element body 10, it is possible to further increase the maximum width W1 of the first wide coil wiring 11w1 in the axis AX direction. As a result, it is possible to further decrease the electrical resistance of the entire coil 110 compared with that in the related art, and it is possible to still further increase the Q value of the inductor component 1.

Similarly, when viewed in the direction orthogonal to the bottom surface 100b, each of external shapes of the second to fourth wide coil wirings 11w2 to 11w4 includes a part conforming to the external shape of the element body 10, and a part of the bottom surface wirings 11b and the top surface wirings 11t which conform to an external shape of a coil wiring adjacent to the wide coil wiring in the axis AX direction on the same plane.

Preferably, when viewed in the direction orthogonal to the bottom surface 100b, a ratio of a total area of the plurality of bottom surface wirings 11b to an area of the bottom surface 100b is 50% or more and 95% or less (i.e., from 50% to 95%), and a ratio of a total area of the plurality of top surface wirings 11t to the area of the bottom surface 100b is 50% or more and 95% or less (i.e., from 50% to 95%).

According to this configuration, by setting the ratio of the total area of the plurality of bottom surface wirings 11b to the area of the bottom surface 100b to 50% or more, it is possible to reduce leakage of magnetic flux to an outer side of the coil 110 in a radial direction thereof. In addition, it is possible to further decrease the electrical resistance of the bottom surface wiring 11b. Further, it is possible to improve the strength of the element body 10, and it is possible to enhance the heat dissipation of the inductor component 1. By setting the ratio of the total area of the plurality of bottom surface wirings 11b to the area of the bottom surface 100b to 95% or less, it is possible to easily perform division into individual inductor components 1. Similarly, by setting a ratio of a total area of the plurality of top surface wirings 11t to the area of the bottom surface 100b to 50% or more, it is possible to reduce leakage of magnetic flux to the outer side of the coil 110 in the radial direction thereof. In addition, it is possible to reduce the electrical resistance of the top surface wirings 11t. Further, it is possible to improve the strength of the element body 10, and it is possible to enhance the heat dissipation of the inductor component 1. By setting the ratio of the area of the plurality of top surface wirings 11t to the area of the bottom surface 100b to 95% or less, it is possible to easily perform division into individual inductor components 1.

In a conventional inductor component, a pattern of coil wirings having the same shape is repeated, and the pattern of the coil wirings is formed on the inner side of the element body 10 so that the coil wirings are not exposed to the outside of the element body 10. Therefore, it is difficult to increase the ratio. In the inductor component 1, since both the plurality of bottom surface wirings 11b and the plurality of top surface wirings 11t include the wide coil wiring, it is possible to increase the ratio. Meanwhile, in a case where the ratio is set to 100% or substantially 100%, a processing difficulty level increases at the time of division, since the coil wirings and the element body 10 are made of different materials from each other. Further, it is conceivable that the coil wirings may be exposed from the element body 10 due to a case where the coil wiring is shifted from a designed position and formed, variations in processing, or the like. Therefore, a side gap is provided inward from the outer surface of the element body 10 to restrict a formation area of the coil wirings. For example, in a case where a dimension of the bottom surface 100b is 0.4 mm×0.2 mm and a size of the side gap is 10 μm, the ratio is 93%.

Preferably, the wide coil wiring is included in at least one group of a first group including the plurality of bottom surface wirings 11b and a second group including the plurality of top surface wirings 11t, and a ratio of a total area of all the coil wirings in a group including the wide coil wiring, of the first group and the second group, to the area of the bottom surface 100b is 65% or more, when viewed in the direction orthogonal to the bottom surface 100b. According to this configuration, it is possible to further reduce leakage of the magnetic flux to the outer side of the coil 110 in the radial direction thereof.

### (First External Electrode 121 and Second External Electrode 122)

The first external electrode 121 is connected to the first end portion of the coil 110, and the second external electrode 122 is connected to the second end portion of the coil 110. The first external electrode 121 is provided on the first end surface 100e1 side with respect to a center of the element body 10 in the X direction to be exposed from the outer surface 100 of the element body 10. The second external electrode 122 is provided on the second end surface 100e2 side with respect to a center of the element body 10 in the X direction to be exposed from the outer surface 100 of the element body 10.

When viewed in the direction orthogonal to the bottom surface 100b, the first external electrode 121 and the second external electrode 122 are preferably positioned on an inner side with respect to the outer surface 100 of the element body 10. That is, the first external electrode 121 and the second external electrode 122 are preferably positioned on an inner side with respect to the first end surface 100e1, the second end surface 100e2, the first side surface 100s1, and the second side surface 100s2 of the element body 10.

According to the configuration described above, since the first external electrode 121 and the second external electrode 122 are not in contact with the outer surfaces 100 of the element body 10, loads applied to the first external electrode 121 and the second external electrode 122 can be decreased, and deformation and peeling of the first external electrode 121 and the second external electrode 122 can be reduced, when division into individual inductor components is performed. Therefore, even if the inductor component has a small size, it is possible to prevent the first external electrode 121 and the second external electrode 122 from being deformed or peeled off.

Note that the first external electrode 121 may be provided to be continuously connected to the bottom surface 100b and the first end surface 100e1. This enables a solder fillet to be formed on the first external electrode 121 when the inductor component 1 is mounted on a mounting substrate, since the first external electrode 121 is a so-called L-shaped electrode. Similarly, the second external electrode 122 may be provided to be continuously connected to the bottom surface 100b and the second end surface 100e2.

The first external electrode 121 has a bottom surface part 121b provided on the bottom surface 100b and a via part 121v embedded in the bottom surface 100b. The via part 121v is connected to the bottom surface part 121b. The via part 121v is connected to the first wide coil wiring 11w.

The second external electrode 122 has a bottom surface part 122b provided on the bottom surface 100b and a via part 122v embedded in the bottom surface 100b. The via part 122v is connected to the bottom surface part 122b. The via part 122v is connected to the second wide coil wiring 11w2.

The first external electrode 121 has a base layer 121e1 and a plating layer 121e2 covering the base layer 121e1. The base layer 121e1 contains, for example, a conductive material such as Ag or Cu. The plating layer 121e2 contains, for example, a conductive material such as Ni or Sn. A part of the bottom surface part 121b and the via part 121v are formed by the base layer 121e1. The other part of the bottom surface part 121b is formed by the plating layer 121e2. Similarly, the second external electrode 122 has a base layer and a plating layer covering the base layer. Note that the first external electrode 121 and the second external electrode 122 may be made of a single-layer conductor material.

In this embodiment, the first external electrode 121 has a plurality of via parts 121v. To be more specific, the first external electrode 121 has two via parts 121v arranged side by side in the Y direction. The two via parts 121v are connected to an end portion of the first wide coil wiring 11w1 on the second side surface 100s2 side. Similarly, the second external electrode 122 has a plurality of via parts 121v. To be more specific, the second external electrode 122 has two via parts 122v arranged side by side in the Y direction. The two via parts 122v are connected to an end portion of the second wide coil wiring 11w2 on the first side surface 100s1 side. Note that the numbers of the via parts 121v and the via parts 122v, respectively, are not particularly limited, and may be three or more. In addition, either a plurality of via parts 121v or a plurality of via parts 122v may be present.

According to this configuration, since the plurality of via parts 121v are connected to the first wide coil wiring 11w1, it is possible to improve the connection strength between the first external electrode 121 and the first wide coil wiring 11w1 as compared with a case where a single via part 121v is connected thereto. Similarly, since the plurality of via parts 122v are connected to the second wide coil wiring 11w2, it is possible to improve the connection strength between the second external electrode 122 and the second wide coil wiring 11w2 as compared with a case where a single via part 122v is connected thereto.

### (Method for Manufacturing Inductor Component 1)

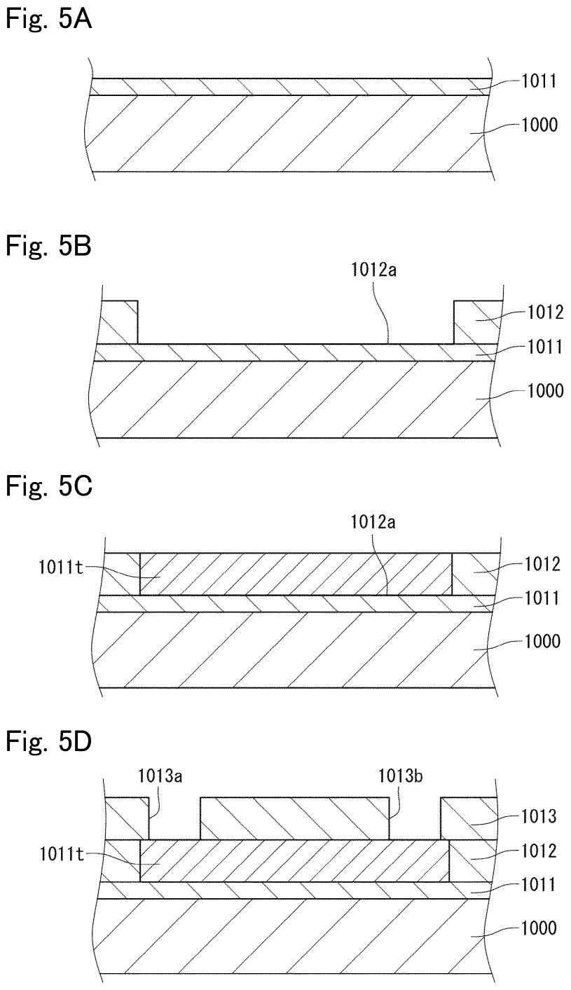

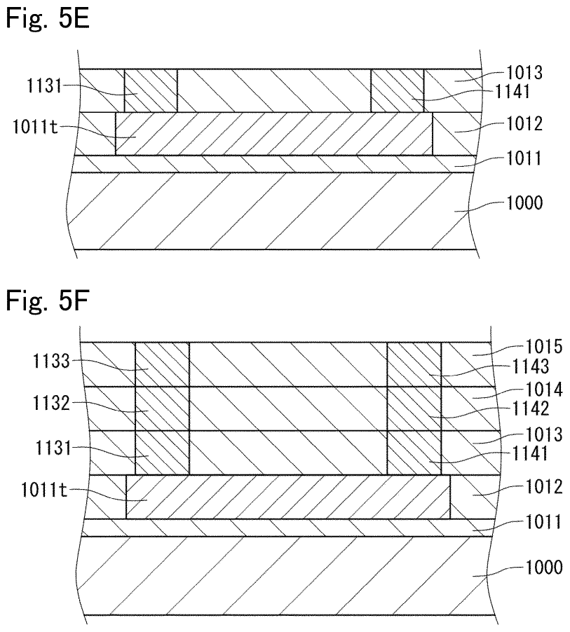

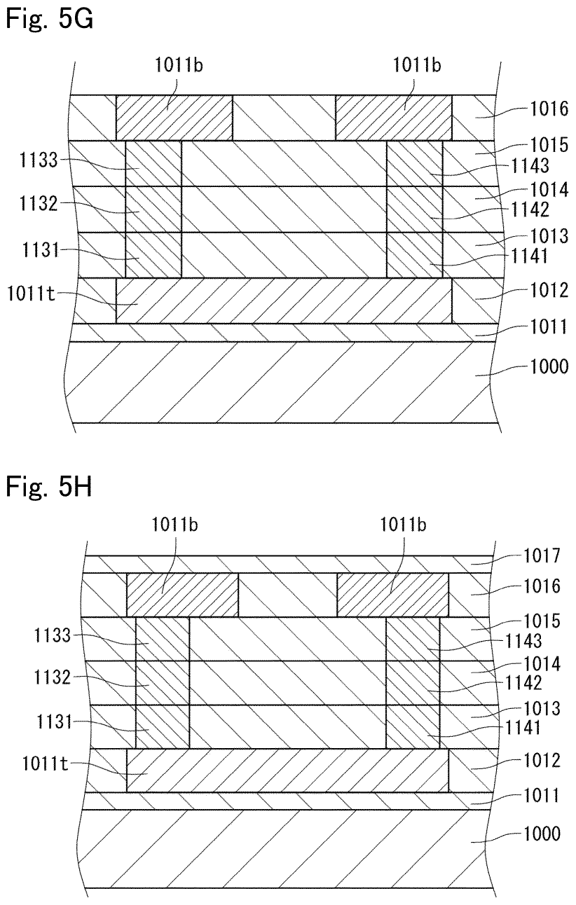

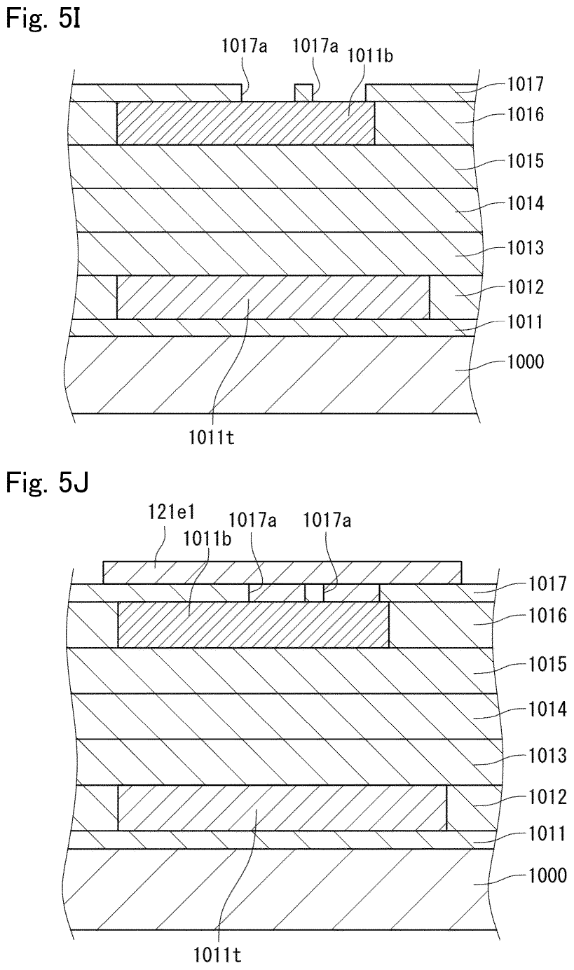

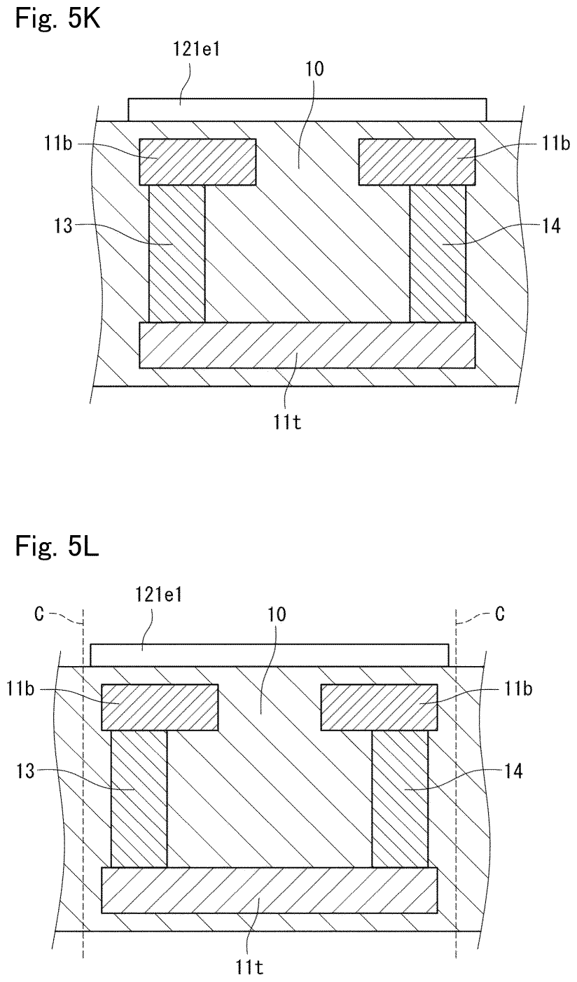

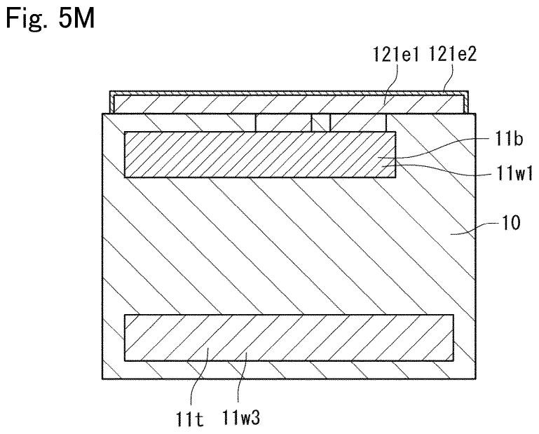

Next, a method for manufacturing the inductor component 1 will be described with reference to FIGS. 5A to 5M. FIGS. 5A to 5H, 5K, and 5L are views corresponding to a cross section taken along line II-II in FIG. 1. FIGS. 5I, 5J, and 5M are views corresponding to a cross section taken along line III-III in FIG. 1.

As shown in FIG. 5A, a first insulating layer 1011 is printed on a base substrate 1000. Examples of materials of the base substrate 1000 include a glass substrate, a silicon substrate, an alumina substrate, or the like, and examples of materials of the first insulating layer 1011 include a resin such as epoxy or polyimide, or an inorganic insulating film such as SiO or SiN.

As shown in FIG. 5B, a second insulating layer 1012 is printed on the first insulating layer 1011. A groove 1012a is provided in the second insulating layer 1012. In this case, for example, the groove 1012a is formed by the photolithography process. Note that the groove may be formed as a printed pattern from the beginning.

As shown in FIG. 5C, a top surface conductor layer 1011t is printed in the groove 1012a. Examples of materials of the top surface conductor layer 1011t include Ag, Cu, Au, Al, an alloy containing at least one of these elements, or a solder paste. In this case, for example, the top surface conductor layer 1011t is formed as a printed pattern to remain only in the groove 1012a. Note that, after the top surface conductor layer 1011t is printed on the second insulating layer 1012, the top surface conductor layer 1011t may remain only in the groove 1012a by the photolithography process.

As shown in FIG. 5D, a third insulating layer 1013 is printed on the second insulating layer 1012. The third insulating layer 1013 has a first groove 1013a and a second groove 1013b. The first groove 1013a and the second groove 1013b are formed in the same method as described in FIG. 5B.

As shown in FIG. 5E, a first penetration conductor layer 1131 as a first layer is printed in the first groove 1013a, and a second penetration conductor layer 1141 as the other first layer is printed in the second groove 1013b. The first penetration conductor layer 1131 as the first layer and the second penetration conductor layer 1141 as the other first layer are formed by the same method described in FIG. 5C.

By repeating the above-described processes, as shown in FIG. 5F, a fourth insulating layer 1014 is provided on the third insulating layer 1013, and a first penetration conductor layer 1132 as a second layer and a second penetration conductor layer 1142 as the other second layer are provided in two respective grooves provided in the fourth insulating layer 1014. Further, a fifth insulating layer 1015 is provided on the fourth insulating layer 1014, and a first penetration conductor layer 1133 as a third layer and a second penetration conductor layer 1143 as the other third layer are provided in two respective grooves provided in the fifth insulating layer 1015.

As shown in FIG. 5G, a sixth insulating layer 1016 is provided on the fifth insulating layer 1015, and a bottom surface conductor layer 1011b is provided in a groove provided in the sixth insulating layer 1016. A material of the bottom surface conductor layer 1011b is the same as the material of the top surface conductor layer 1011t. As shown in FIG. 5H, a seventh insulating layer 1017 is provided on the sixth insulating layer 1016.

As shown in FIG. 5I, a groove 1017a is provided in the seventh insulating layer 1017 such that a part of the bottom surface conductor layer 1011b is exposed. As shown in FIG. 5J, a base conductor layer 1121e1 is provided on the seventh insulating layer 1017 and in the groove 1017a. Examples of materials of the base conductor layer 1121e1 include resin pastes of Ag or Cu.

As shown in FIG. 5K, an entire layered body is sintered in a furnace at a high temperature (for example, 500° C. or higher). The first to seventh insulating layers 1011 to 1017 are sintered to form the element body 10, the top surface conductor layer 1011t is sintered to form the top surface wiring 11t, the bottom surface conductor layer 1011b is sintered to form the bottom surface wiring 11b, the first penetration conductor layers 1131 to 1133 as the first to third layers are sintered to form the first penetration wiring 13, the second penetration conductor layers 1141 to 1143 as the first to third other layers are sintered to form the second penetration wiring 14, and the base conductor layer 1121e1 is sintered to form the base layer 121e1. Hence, it is possible to improve the strength by sintering the insulating layers, and a resin component which does not need to be contained in the conductor layers can be volatilized by sintering the conductor layers, and a conductor material contained in the conductor layers can be fused to realize high conductivity. The base substrate 1000 may be peeled off by decomposing a surface during sintering, may be mechanically removed by performing grinding or the like before and after the sintering, or may be chemically removed by performing etching or the like before and after the sintering.

As shown in FIG. 5L, division into individual inductor components is performed along a cutting line C. As shown in FIG. 5M, the plating layer 121e2 is formed by performing barrel plating to cover the base layer 121e1, and the first external electrode 121 is formed. Consequently, as shown in FIG. 2, the inductor component 1 is manufactured.

### 3. Modification Examples

### First Modification Example

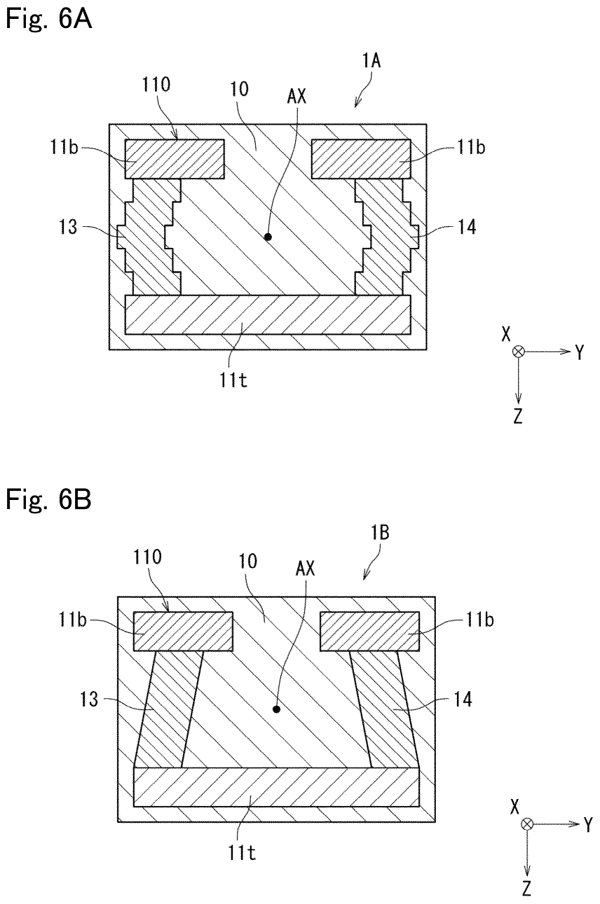

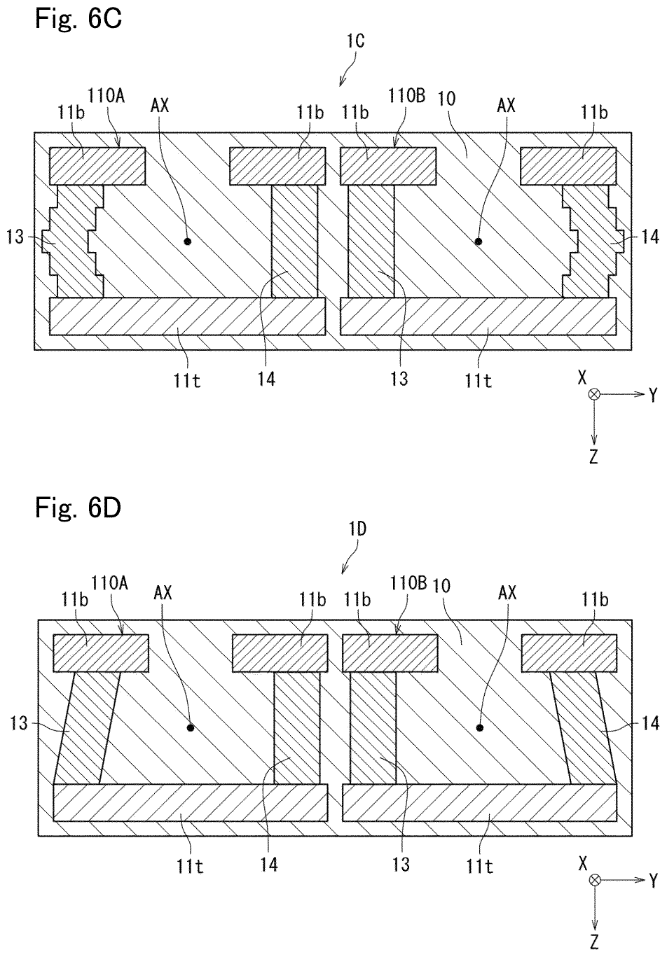

FIG. 6A is a view showing a first modification example of the inductor component, and the view corresponds to the cross section taken along line II-II in FIG. 1. As shown in FIG. 6A, in an inductor component 1A of the first modification example, the first penetration wiring 13 and the second penetration wiring 14 are not parallel to each other when viewed in the direction parallel to the axis AX of the coil 110. This enables a distance between the first penetration wiring 13 and the second penetration wiring 14 to be increased and enables the inner diameter of the coil 110 to be increased such that it is possible to improve the Q value.

To be more specific, the first penetration wiring 13 and the second penetration wiring 14 are bent at respective centers thereof in the Z direction such that a space therebetween is widened toward the centers. That is, each of the first penetration wiring 13 and the second penetration wiring 14 has a shape expanding outward in a radial direction of the coil 110 toward the center in the Z direction. In addition, each of the first penetration wiring 13 and the second penetration wiring 14 has a stepped shape in the Z direction. According to the configuration described above, in a case where the first penetration wiring 13 and the second penetration wiring 14 are each formed by layering a plurality of conductor layers, the first penetration wiring 13 and the second penetration wiring 14 can be easily formed in the stepped shape by shifting and layering each conductor layer.

### Second Modification Example

FIG. 6B is a view showing a second modification example of the inductor component, and the view corresponds to the cross section taken along line II-II in FIG. 1. As shown in FIG. 6B, in an inductor component 1B of the second modification example, the first penetration wiring 13 and the second penetration wiring 14 are not parallel to each other when viewed in the direction parallel to the axis AX of the coil 110. This enables a distance between the first penetration wiring 13 and the second penetration wiring 14 to be increased and enables the inner diameter of the coil 110 to be increased such that it is possible to improve the Q value.

To be more specific, the first penetration wirings 13 and the second penetration wirings 14 are inclined such that a space therebetween is widened toward the top surface wiring 11t side in the Z direction. That is, each of the first penetration wirings 13 and the second penetration wirings 14 has a shape expanding outward in the radial direction of the coil 110 toward the top surface wiring 11t in the Z direction. As described above, the coil 110 has a trapezoidal shape when viewed from the axis AX direction. According to the configuration described above, the first penetration wirings 13 and the second penetration wirings 14 can be linearly formed and shortened, and the DC resistance of the first penetration wirings 13 and the second penetration wirings 14 can be reduced.

### Third Modification Example

FIG. 6C is a view showing a third modification example of the inductor component, and the view corresponds to the cross section taken along line II-II in FIG. 1. As shown in FIG. 6C, an inductor component 1C of the third modification example includes a first coil 110A and a second coil 110B as compared with the inductor component 1A of the first modification example shown in FIG. 6A.

In the first coil 110A, the first penetration wiring 13 and the second penetration wiring 14 are not parallel to each other when viewed in the direction parallel to the axis AX. This enables a distance between the first penetration wiring 13 and the second penetration wiring 14 to be increased and enables the inner diameter of the coil 110A to be increased such that it is possible to improve the Q value.

To be more specific, the first penetration wiring 13 has the same configuration as that of the first penetration wiring 13 of the inductor component 1A of the first modification example. Meanwhile, the second penetration wiring 14 has a linear shape parallel to the Z direction. That is, the first penetration wiring 13 is bent at a center thereof in the Z direction such that a space between the first penetration wiring 13 and the second penetration wiring 14 is widened toward the center. The first penetration wiring 13 has a stepped shape in the Z direction. According to the configuration described above, in a case where the first penetration wiring 13 is formed by layering a plurality of conductor layers, the first penetration wiring 13 can be easily formed in the stepped shape by shifting and layering each conductor layer.

In the second coil 110B, the first penetration wiring 13 and the second penetration wiring 14 are not parallel to each other when viewed in the direction parallel to the axis AX. This enables a distance between the first penetration wiring 13 and the second penetration wiring 14 to be increased and enables the inner diameter of the coil 110B to be increased such that it is possible to improve the Q value.

To be more specific, the second penetration wiring 14 has the same configuration as that of the second penetration wiring 14 of the inductor component 1A of the first modification example. Meanwhile, the first penetration wiring 13 has a linear shape parallel to the Z direction. That is, the second penetration wiring 14 is bent at a center thereof in the Z direction such that a space between the first penetration wiring 13 and the second penetration wiring 14 is widened toward the center. The second penetration wiring 14 has a stepped shape in the Z direction. According to the configuration described above, in a case where the second penetration wiring 14 is formed by layering a plurality of conductor layers, the second penetration wiring 14 can be easily formed in the stepped shape by shifting and layering each conductor layer.

### Fourth Modification Example

FIG. 6D is a view showing a fourth modification example of the inductor component, and the view corresponds to the cross section taken along line II-II in FIG. 1. As shown in FIG. 6D, an inductor component 1D of the fourth modification example includes a first coil 110A and a second coil 110B as compared with the inductor component 1B of the second modification example shown in FIG. 6B.

In the first coil 110A, the first penetration wiring 13 and the second penetration wiring 14 are not parallel to each other when viewed in the direction parallel to the axis AX. This enables a distance between the first penetration wiring 13 and the second penetration wiring 14 to be increased and enables the inner diameter of the coil 110A to be increased such that it is possible to improve the Q value.

To be more specific, the first penetration wiring 13 has the same configuration as that of the first penetration wiring 13 of the inductor component 1B of the second modification example. Meanwhile, the second penetration wiring 14 has a linear shape parallel to the Z direction. That is, the first penetration wiring 13 is inclined such that a space between the first penetration wiring 13 and the second penetration wiring 14 is widened toward the top surface wiring 11t side in the Z direction. According to the configuration described above, the first penetration wirings 13 and the second penetration wirings 14 can be linearly formed and shortened, and the DC resistance of the first penetration wirings 13 and the second penetration wirings 14 can be reduced.

In the second coil 110B, the first penetration wiring 13 and the second penetration wiring 14 are not parallel to each other when viewed in the direction parallel to the axis AX. This enables a distance between the first penetration wiring 13 and the second penetration wiring 14 to be increased and enables the inner diameter of the coil 110B to be increased such that it is possible to improve the Q value.

To be more specific, the second penetration wiring 14 has the same configuration as that of the second penetration wiring 14 of the inductor component 1B of the second modification example. Meanwhile, the first penetration wiring 13 has a linear shape parallel to the Z direction. That is, the second penetration wiring 14 is inclined such that a space between the first penetration wiring 13 and the second penetration wiring 14 is widened toward the top surface wiring 11t side in the Z direction. According to the configuration described above, the first penetration wirings 13 and the second penetration wirings 14 can be linearly formed, and the electrical resistance of the first penetration wirings 13 and the second penetration wirings 14 can be reduced.

### Second Embodiment

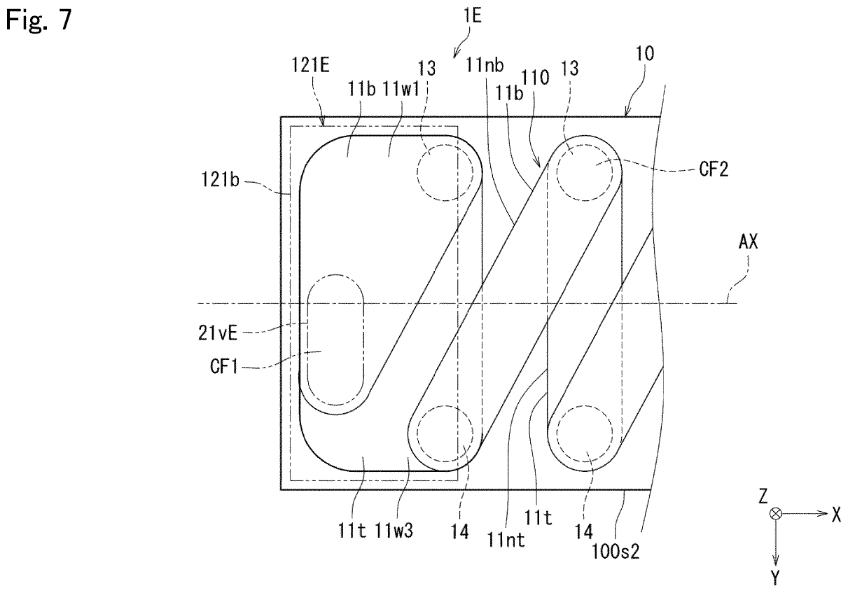

FIG. 7 is a schematic bottom view of a second embodiment of the inductor component from the bottom surface side. In FIG. 7, an external electrode is drawn by a two-dot chain line for convenience. In addition, in FIG. 7, the element body 10 is drawn transparently so that a structure thereof can be easily understood. In FIG. 7, description of the second end surface side of the element body is omitted for convenience. The second embodiment differs from the first embodiment in that the via part of the external electrode has a different configuration, and the different configuration will be described below. The other configurations are the same as those of the first embodiment, and the description thereof will be omitted.

As shown in FIG. 7, a first external electrode 121E has a via part 121vE connected to the coil 110, the via part 121vE is connected to the first wide coil wiring 11w1, and an area of a contact surface CF1 of the first wide coil wiring 11w1 with the via part 121vE is larger than an area of a contact surface CF2 of the narrow bottom surface wiring 11nb and the narrow top surface wiring 11nt with the first penetration wiring 13.

To be more specific, the first external electrode 121E has a single via part 121vE. The via part 121vE is connected to an end portion of the first wide coil wiring 11w1 on the second side surface 100s2 side. A shape of the via part 121vE is an elliptical shape having a major axis parallel to the Y direction when viewed in the Z direction. The area of the contact surface CF1 of the first wide coil wiring 11w1 with the via part 121vE is larger than the area of the contact surface CF2 of the narrow bottom surface wiring 11nb with the first penetration wiring 13. According to this configuration, it is possible to improve connection strength between the first external electrode 121E and the first wide coil wiring 11w1.

Although not shown, the via part of the second external electrode 122 may have the same configuration as that of the via part 121vE, and has the same operation and effects as those of the via part 121vE described above.

### Third Embodiment

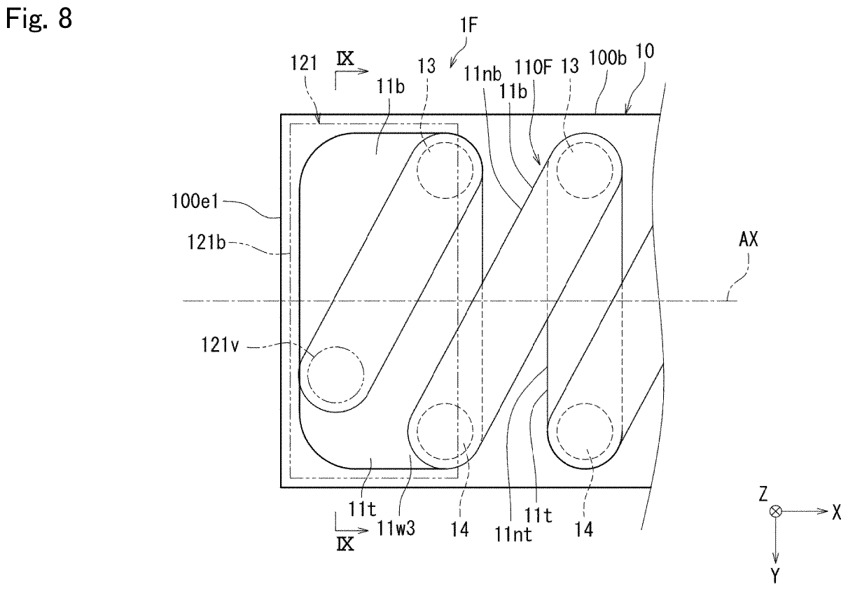

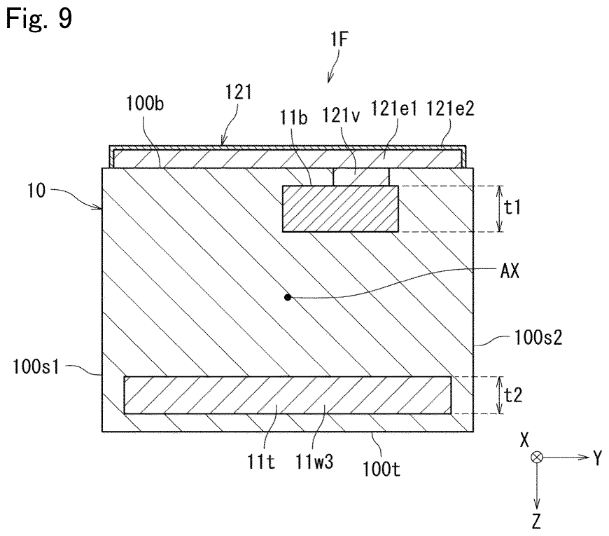

FIG. 8 is a schematic bottom view of a third embodiment of the inductor component from the bottom surface side. FIG. 9 is a cross-sectional view taken along line IX-IX in FIG. 8. In FIG. 8, an external electrode is drawn by a two-dot chain line for convenience. In addition, in FIG. 8, the element body 10 is drawn transparently so that a structure thereof can be easily understood. In FIG. 8, description of the second end surface side of the element body is omitted for convenience. The third embodiment differs from the first embodiment in that the wide coil wiring is not present on the bottom surface wiring side and the wide coil wiring on the top surface wiring side has a different thickness, and the different configuration will be described below. The other configurations are the same as those of the first embodiment, and the description thereof will be omitted.

As shown in FIGS. 8 and 9, a thickness of the third wide coil wiring 11w3 is smaller than thicknesses of the narrow bottom surface wiring 11nb and the narrow top surface wiring 11nt.

To be more specific, in this embodiment, the bottom surface wiring 11b positioned closest to the first end surface 100e1 is not a wide coil wiring. The bottom surface wiring 11b extends linearly in a direction parallel to the narrow bottom surface wiring 11nb. A wiring width of the bottom surface wiring 11b is the same as a wiring width of the narrow bottom surface wiring 11nb. In addition, although not shown, the thickness of the bottom surface wiring 11b in the Z direction is the same as the thickness of the narrow bottom surface wiring 11nb in the Z direction.

A thickness t2 of the third wide coil wiring 11w3 in the Z direction is smaller than a thickness t1 of the bottom surface wiring 11b positioned closest to the first end surface 100e1 in the Z direction. In other words, the thickness t2 of the third wide coil wiring 11w3 in the Z direction is smaller than the thickness of the narrow bottom surface wiring 11nb (not shown) in the Z direction. Note that the thickness t2 of the third wide coil wiring 11w3 may be thinner than a thickness of at least one coil wiring of the plurality of narrow bottom surface wirings 11nb and the plurality of narrow top surface wirings 11nt.

Since the third wide coil wiring 11w3 has a relatively large maximum width in the axis AX direction, it is possible to reduce an increase in the electrical resistance even if the thickness is decreased. Therefore, according to the configuration described above, it is possible to decrease the electrical resistance of the entire coil 110F compared with that in the related art, and it is possible to realize a thin inductor component 1F.

Preferably, the first external electrode 121 is provided on the bottom surface 100b of the element body 10, and the wide coil wiring is included only in the plurality of top surface wirings 11t. According to this configuration, it is possible to increase a distance between the wide coil wiring and the first external electrode 121 as compared with a case where the wide coil wiring is included in the plurality of bottom surface wirings 11b. Therefore, it is possible to decrease parasitic capacitance between the wide coil wiring and the first external electrode 121, and it is possible to increase the self-resonant frequency (SRF). Similarly, the second external electrode 122 may be provided on the bottom surface 100b of the element body 10, and the wide coil wiring may be included only in the plurality of top surface wirings 11t.

Preferably, the wide coil wiring is included in only one group of the first group including the plurality of bottom surface wirings 11b and the second group including the plurality of top surface wirings 11t, and a thickness of all the coil wirings in the group including the wide coil wiring of the first group and the second group is smaller than a thickness of all the coil wirings in the group without including the wide coil wiring. According to this configuration, it is possible to realize the thinner inductor component 1F.

### Fourth Embodiment

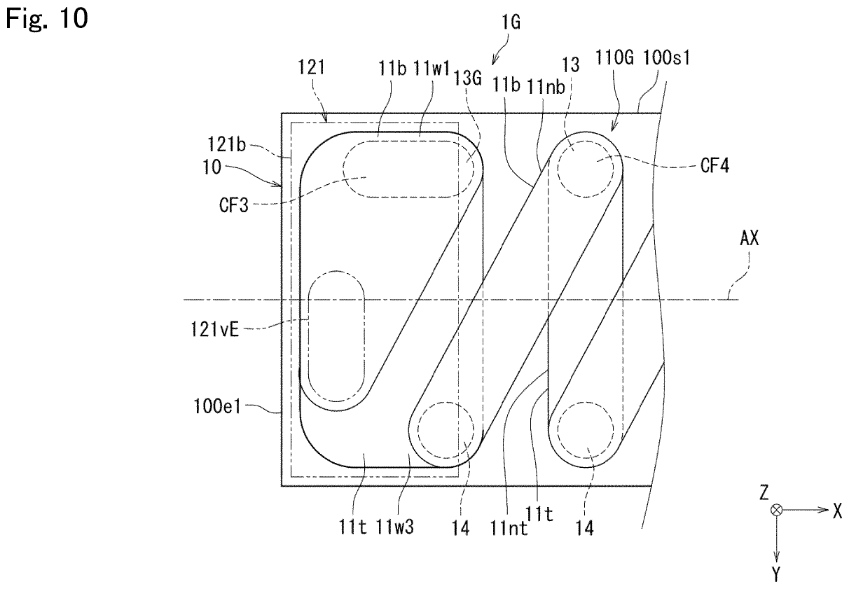

FIG. 10 is a schematic bottom view of a fourth embodiment of the inductor component from the bottom surface side. In FIG. 10, an external electrode is drawn by a two-dot chain line for convenience. In addition, in FIG. 10, the element body 10 is drawn transparently so that a structure thereof can be easily understood. In FIG. 10, description of the second end surface side of the element body is omitted for convenience. The fourth embodiment differs from the third embodiment in that the first penetration wiring connected to the wide coil wiring has a different configuration, and the different configuration will be described below. The other configurations are the same as those of the third embodiment, and the description thereof will be omitted.

As shown in FIG. 10, the first wide coil wiring 11w1 is connected to a first penetration wiring 13G, and an area of a contact surface CF3 of the first wide coil wiring 11w1 with the first penetration wiring 13G is larger than an area of a contact surface CF4 of the narrow bottom surface wiring 11nb and the narrow top surface wiring 11nt with the first penetration wiring 13.

To be more specific, the first penetration wiring 13G positioned closest to the first end surface 100e1 is connected to an end portion of the first wide coil wiring 11w1 on the first side surface 100s1 side. A shape of the first penetration wiring 13G is an elliptical shape having a major axis parallel to the X direction when viewed in the Z direction. An area of a contact surface CF3 of the first wide coil wiring 11w1 with the first penetration wiring 13G is larger than an area of a contact surface CF4 of the narrow bottom surface wiring 11nb with the first penetration wiring 13.

According to the configuration described above, it is possible to further decrease the electrical resistance of the first penetration wiring 13G connected to the first wide coil wiring 11w1 than the electrical resistance of the other first penetration wirings 13. As a result, it is possible to decrease the electrical resistance of the entire coil 110G compared with that in the related art.

In addition, although not shown, the second penetration wiring connected to the second wide coil wiring 11w2 may have the same configuration as that of the first penetration wiring 13G, and has the same operation and effect as those of the first penetration wiring 13G.

### Fifth Embodiment

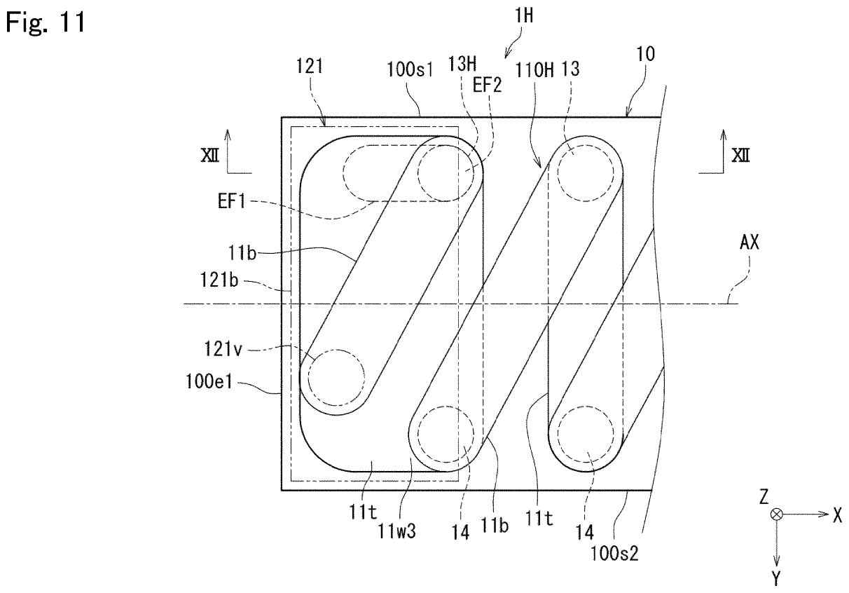

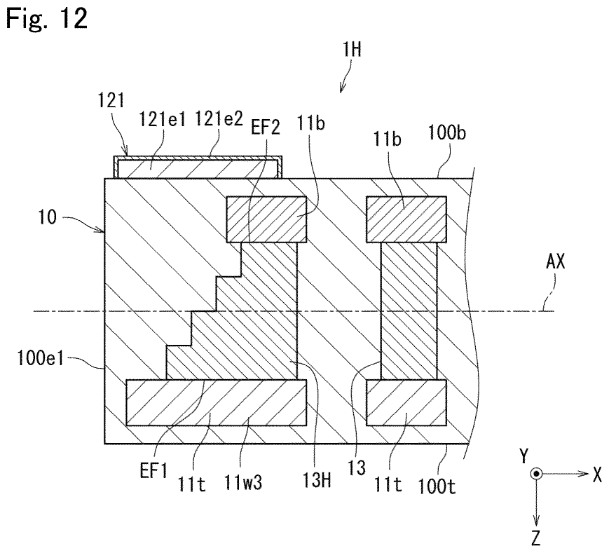

FIG. 11 is a schematic bottom view of a fifth embodiment of the inductor component from the bottom surface side. FIG. 12 is a cross-sectional view taken along line XII-XII in FIG. 11. In FIG. 11, an external electrode is drawn by a two-dot chain line for convenience. In addition, in FIG. 11, the element body 10 is drawn transparently so that a structure thereof can be easily understood. In FIG. 11, description of the second end surface side of the element body is omitted for convenience. The fifth embodiment differs from the third embodiment in that the first penetration wiring connected to the wide coil wiring has a different configuration, and the different configuration will be described below. The other configurations are the same as those of the third embodiment, and the description thereof will be omitted.

As shown in FIGS. 11 and 12, a first end surface EF1 of a first penetration wiring 13H in the extending direction is connected to the top surface wiring 11t. The first end surface EF1 is an end surface of the first penetration wiring 13H on the top surface 100t side. A second end surface EF2 of the first penetration wiring 13H in the extending direction is connected to the bottom surface wiring 11b. The second end surface EF2 is an end surface of the first penetration wiring 13H on the bottom surface 100b side. The third wide coil wiring 11w3 is connected to the first end surface EF1. An area of the first end surface EF1 is larger than an area of the second end surface EF2.

To be more specific, the first penetration wiring 13H positioned closest to the first end surface 100e1 has a side surface having a stepped shape such that a width thereof in the X direction increases in a stepped manner from the bottom surface 100b side toward the top surface 100t side, in a cross section of the first penetration wiring 13H in the extending direction. Therefore, the area of the first end surface EF1 is larger than the area of the second end surface EF2.

According to the configuration described above, it is possible to further decrease the electrical resistance of the first penetration wiring 13H connected to the third wide coil wiring 11w3 than the electrical resistance of the other first penetration wirings 13. As a result, it is possible to decrease the electrical resistance of an entire coil 110H compared with that in the related art.

Note that, as long as the area of the first end surface EF1 is larger than the area of the second end surface EF2, the first penetration wiring 13H may not have the stepped shape. For example, the first penetration wiring 13H may have a side surface formed in a linear shape, a curved shape, or a combined shape thereof such that a width thereof in the X direction increases from the bottom surface 100b side toward the top surface 100t side, in a cross section including a center line of the first penetration wiring 13H. In other words, in the first penetration wiring 13H, an area of a cross section orthogonal to the extending direction may increase in a continuous or stepwise manner from the second end surface EF2 toward the first end surface EF1.

In addition, although not shown, the second penetration wiring positioned closest to the second end surface 100e2 may have the same configuration as that of the first penetration wiring 13H, and has the same operation and effect as those of the first penetration wiring H described above.

### Sixth Embodiment

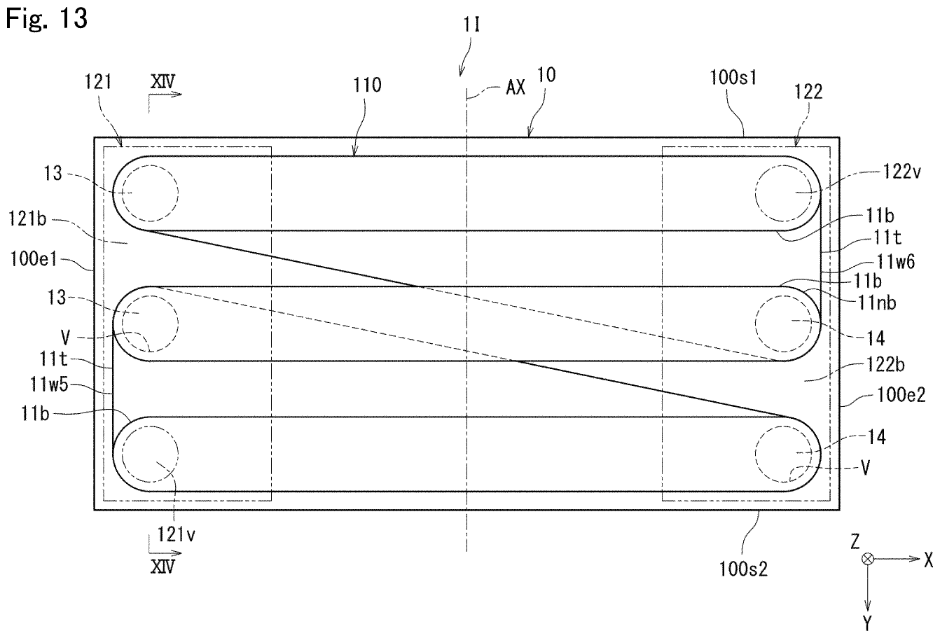

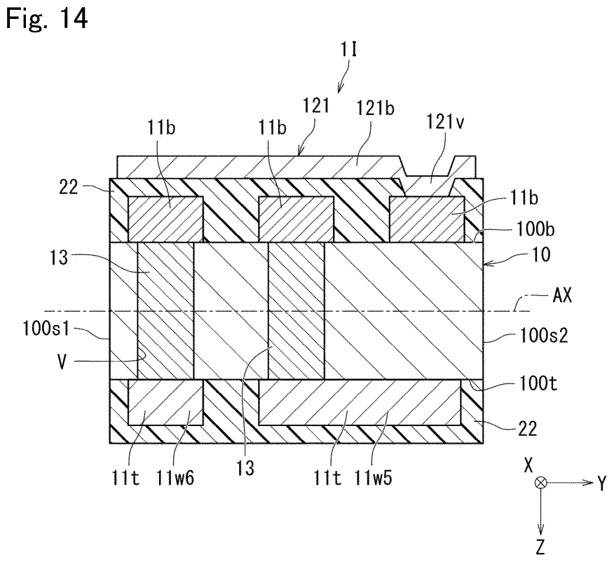

FIG. 13 is a schematic bottom view of a sixth embodiment of the inductor component from the bottom surface side. FIG. 14 is a cross-sectional view taken along line XIV-XIV in FIG. 13. In FIG. 13, for convenience, an insulating layer is omitted, and the external electrodes are drawn by two-dot chain lines. In addition, in FIG. 13, the element body 10 is drawn transparently so that a structure thereof can be easily understood. The sixth embodiment differs from the first embodiment mainly in the position of the axis of the coil, the configuration of the wide coil wiring, the orientation of the penetration wiring, the material of the element body, and providing of an insulating layer, and these different configurations will be mainly described below. The other configurations are the same as those of the first embodiment, and the description thereof will be omitted.

### 1. Configurations of Respective Units

### (Inductor Component 11)

As shown in FIG. 13, in an inductor component 11, an axis AX of a coil 110 is perpendicular to the X direction. To be more specific, the axis AX is parallel to the Y direction and passes a center of the element body 10 in the X direction. This enables interference in magnetic flux of the coil 110 by the first external electrode 121 and the second external electrode 122 to be reduced, and it is possible to improve the efficiency of acquisition of inductance.

A length of the coil 110 in the axis AX direction is shorter than an inner diameter of the coil 110. This enables the Q value to be improved since the coil length is short and the coil inner diameter is large. The inner diameter of the coil indicates an equivalent circle diameter based on a minimum area of a region surrounded by the coil 110 when viewed therethrough in the axis AX direction.

### (Element Body 10)

The element body 10 is an inorganic insulating body. The material of the element body 10 is preferably glass, and this enables an eddy current to be reduced and enables the Q value to be increased since the glass has high insulation properties. The element body 10 preferably contains an Si element, and this enables the thermal stability of the element body 10 to be increased, thus, enabling variations in dimension or the like of the element body 10 due to heat to be reduced and enabling variations in electrical characteristics to be decreased.

The element body 10 is preferably a single-layer glass plate. This enables the strength of the element body 10 to be ensured. In addition, in the case of the single-layer glass plate, since dielectric loss is small, the Q value at a high frequency can be increased. In addition, since no sintering process for such a sintered body is performed, deformation of the element body 10 during sintering can be reduced. Hence, it is possible to reduce pattern misalignment and provide an inductor component with a small inductance tolerance.

As a material of the single-layer glass plate, a glass plate having photosensitivity represented by Foturan II (Schott AG's registered trademark) is preferable from the viewpoint of a manufacturing method. In particular, the single-layer glass plate preferably contains cerium oxide (ceria: CeO₂), and in this case, cerium oxide serves as a sensitizer, and processing by photolithography becomes easier.

However, since the single-layer glass plate can be processed by machining such as drilling or sandblasting, dry/wet etching using a photoresist/metal mask, laser processing, or the like, the single-layer glass plate may be a non-photosensitive glass plate. In addition, the single-layer glass plate may be obtained by sintering a glass paste, or may be formed by a known method such as a float process.

### (Insulating Body 22)

As shown in FIG. 14, the inductor component 11 includes an insulating body 22. The insulating body 22 covers both the bottom surface 100b and the top surface 100t of the element body 10. Note that the insulating body 22 may be provided only on the bottom surface 100b of the bottom and top surfaces 100b and 1100t.

The insulating body 22 is a member that protects the wirings from an external force by covering the wirings (the bottom surface wirings 11b and the top surface wirings 11t), and has a role of preventing the wirings from being damaged and a role of improving insulation properties of the wirings. The insulating body 22 is preferably an organic insulating body. For example, the insulating body 22 may be a film made of a resin such as epoxy or polyimide which is easily formed. In particular, the insulating body 22 is preferably made of a material having a low dielectric constant. Consequently, in a case where the insulating body 22 is present between the coil 110 and the external electrode 121 or 122, it is possible to decrease the stray capacitance formed between the coil 110 and the external electrode 121 or 122. The insulating body 22 can be formed, for example, by laminating a resin film such as ABF GX-92 (manufactured by Ajinomoto Fine-Techno Co., Inc.), applying and thermal-curing a paste-like resin, or the like. Note that the insulating body 22 may be, for example, an inorganic film made of an oxide such as silicon or hafnium, a nitride, an oxynitride, or the like, which is excellent in insulating properties and thinning.

Preferably, when the element body 10 is the inorganic insulating body, and the insulating body 22 is an organic insulating body, the organic insulating body is positioned on an inner side with respect to the outer surfaces 100 of the inorganic insulating body when viewed in the direction orthogonal to the bottom surface 100b. According to this, since the organic insulating body is provided and easily imparts flowability, and thus is easily filled into a space between wirings adjacent to each other and enables insulating properties to be improved, in a case where the wirings (the bottom surface wirings 11b and the top surface wirings 11t) are covered with the organic insulating body. In addition, since the organic insulating body is not in contact with the outer surface of the inorganic insulating body, it is possible to decrease a load applied to the organic insulating body and reduce deformation and peeling of the organic insulating body when division into individual inductor components is performed.

### (Coil 110)

As shown in FIG. 13, the bottom surface wiring 11b extends only in one direction. To be more specific, the bottom surface wirings 11b have a shape extending in the X direction. The plurality of bottom surface wirings 11b are arranged parallel to each other in the Y direction. In this embodiment, the bottom surface wirings 11b have the same wiring width, and the coil wirings positioned at both ends in the axis AX direction, of the plurality of bottom surface wirings 11b, are not wide coil wirings.

The plurality of top surface wirings 11t include only the wide coil wirings. To be more specific, the plurality of top surface wirings 11t include a fifth wide coil wiring 11w5 disposed on the second side surface 100s2 side of the element body 10 and a sixth wide coil wiring 11w6 disposed on the first side surface 100s1 side of the element body 10. The fifth wide coil wiring 11w5 has substantially a triangular shape in which a width thereof in the axis AX direction decreases from the first end surface 100e1 side toward the second end surface 100e2 side of the element body 10 when viewed in the Z direction. The sixth wide coil wiring 11w6 is formed in substantially a triangular shape in which a width thereof in the axis AX direction decreases from the second end surface 100e2 side toward the first end surface 100e1 side of the element body 10 when viewed in the Z direction.

The first penetration wirings 13 are disposed in the through-holes V of the element body 10 on the first end surface 100e1 side with respect to the axis AX, and the second penetration wirings 14 are disposed in the other through-holes V of the element body 10 on the second end surface 100e2 side with respect to the axis AX. Each of the first penetration wirings 13 and the second penetration wirings 14 extends in a direction orthogonal to the bottom surface 100b and the top surface 100t. The plurality of first penetration wirings 13 and the plurality of second penetration wirings 14 are all arranged parallel to each other in the Y direction.

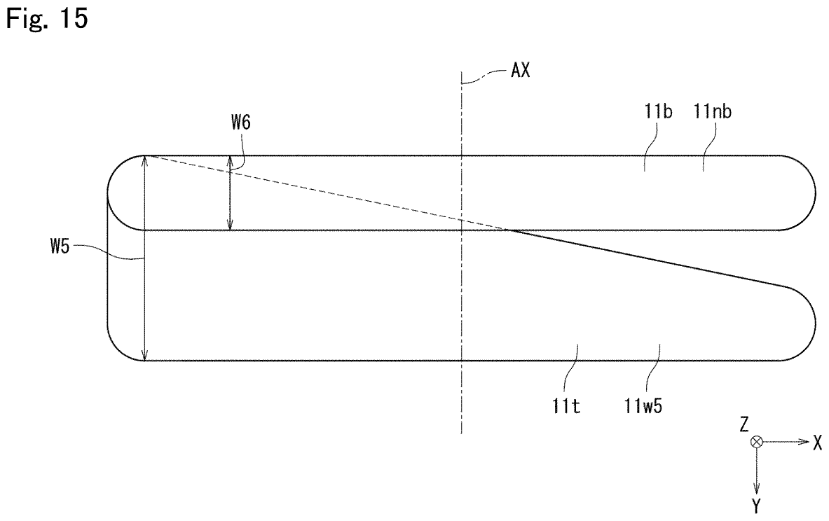

FIG. 15 is an enlarged view of a part of FIG. 13. To be more specific, FIG. 15 is an enlarged view of the fifth wide coil wiring 11w5 and the narrow bottom surface wiring 11nb. As shown in FIG. 15, a maximum width W5 of the fifth wide coil wiring 11w5 in the axis AX direction is larger than a maximum width W6 of the narrow bottom surface wiring 11nb in the axis AX direction. The same applies to the sixth wide coil wiring 11w6. That is, a maximum width of the sixth wide coil wiring 11w6 in the axis AX direction is larger than the maximum width W6 of the narrow bottom surface wiring 11nb in the axis AX direction.

According to the configuration described above, when viewed in the direction orthogonal to the bottom surface 100b of the element body 10, at least a part of the fifth wide coil wiring 11w5 and the sixth wide coil wiring 11w6 can be disposed in the dead space at both ends of the element body 10 in the axis AX direction where no coil wiring is present in the related art. As a result, while the dead space of the element body 10 is effectively utilized, it is possible to decrease the electrical resistance of the entire coil 110 compared with that in the related art, and it is possible to increase the Q value of the inductor component 11.

In addition, since the plurality of top surface wirings 11t include only the wide coil wirings, it is possible to decrease the electrical resistance of the entire coil 110 compared with that in the related art in an inductor component having a small number of turns.

Preferably, the wide coil wiring is included in only one group of the first group including the plurality of bottom surface wirings 11b and the second group including the plurality of top surface wirings 11t, and when viewed in the direction orthogonal to the bottom surface 100b, a ratio of a total area of all the coil wirings in the group including the wide coil wiring, of the first group and the second group, to the area of the bottom surface 100b is lower than a ratio of a total area of all the coil wirings in the group without including the wide coil wiring.

To be more specific, as described above, the coil 110 includes the fifth wide coil wiring 11w5 and the sixth wide coil wiring 11w6 as the wide coil wirings, and the fifth wide coil wiring 11w5 and the sixth wide coil wiring 11w6 are included only in the second group from the first group and the second group. When viewed in the direction orthogonal to the bottom surface 100b, the ratio of the total area of all the top surface wirings 11t (that is, the fifth wide coil wiring 11w5 and the sixth wide coil wiring 11w6) in the second group to the area of the bottom surface 100b is higher than a ratio of a total area of all the bottom surface wirings 11b in the first group to the area of the bottom surface 100b. As an example, a ratio of a total area of all the top surface wirings 11t is 70.5%, and the ratio of the total area of all the bottom surface wirings 11b is 55.7%.

According to the configuration described above, it is possible to increase the ratio of all the top surface wirings 11t in the second group including the wide coil wiring while the number of turns of the coil 110 is secured. Consequently, it is possible to reduce the leakage of the magnetic flux to the outer side of the coil 110 in the radial direction thereof. To be more specific, in a case where the plurality of top surface wirings 11t do not include the wide coil wiring, it is conceivable that each top surface wiring 11 may have a shape which slightly tilts in the Y direction and linearly extends in the X direction. In this case, the number of turns is about two, and the ratio is lower than that in a case where the plurality of top surface wirings 11t include the wide coil wiring. Meanwhile, according to the configuration described above, it is possible to increase the ratio than that in the case where the plurality of top surface wirings 11t do not include the wide coil wiring while about two turns are secured as the number of turns.

### (Method for Manufacturing Inductor Component 11)

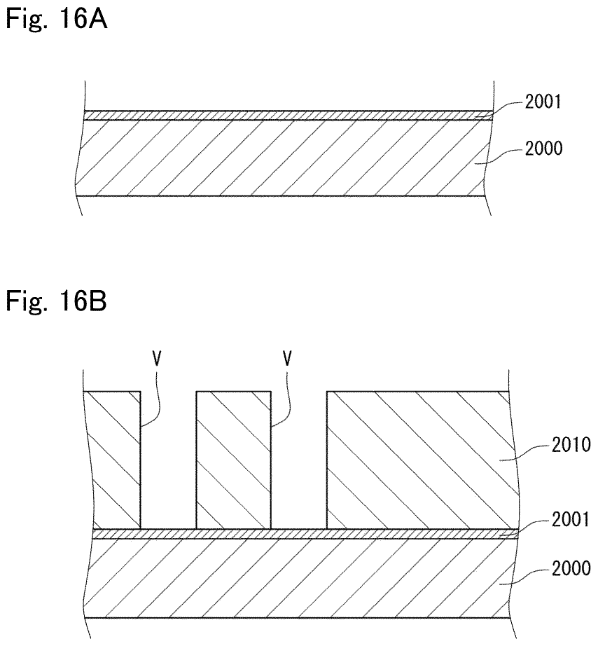

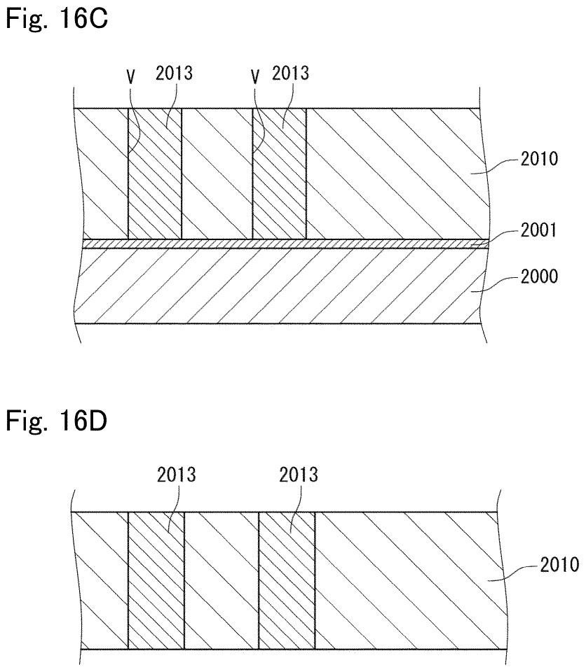

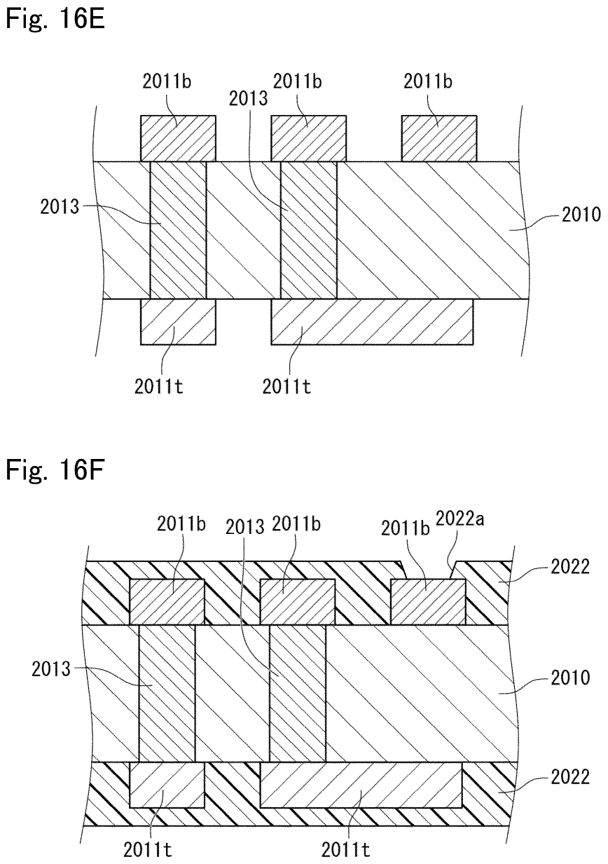

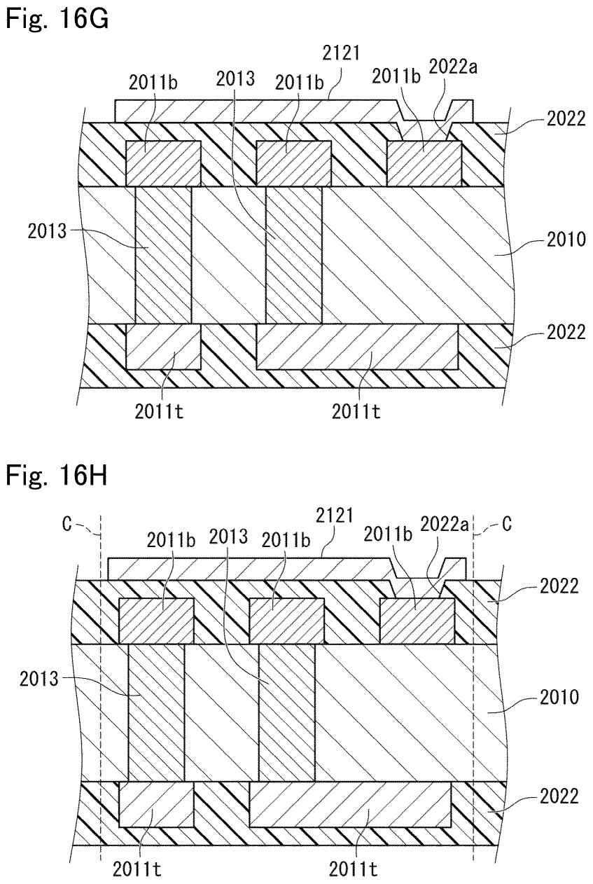

Next, a method for manufacturing the inductor component 11 will be described with reference to FIGS. 16A to 16H. FIGS. 16A to 16H are views corresponding to a cross section taken along line XIV-XIV in FIG. 13.

As shown in FIG. 16A, copper foil 2001 is printed on a base substrate 2000. A material of the base substrate 2000 is the same as that of the base substrate 1000 of the first embodiment.

As shown in FIG. 16B, a glass substrate 2010 which becomes the element body 10 is provided on the base substrate 2000. For example, the base substrate 2000 and the glass substrate 2010 are brought into close contact with each other using a jig such as a conductive tape, a pin, or a frame. The glass substrate 2010 has a through-hole V. The glass substrate 2010 is, for example, a through glass via (TGV) substrate. The TGV substrate is a substrate in which a through-hole is formed in advance by a laser, photolithography, or the like. The glass substrate 2010 may be, for example, a through silicon via (TSV) substrate, or may be another substrate. In addition, Ti/Cu or other necessary conductive materials may be deposited on a surface of the glass substrate 2010 in advance as seeds by sputtering or the like.

As shown in FIG. 16C, a first penetration conductor layer 2013 which becomes the first penetration wiring 13 is formed in the through-hole V of the glass substrate 2010. Although not shown, similarly, a second penetration conductor layer which becomes the second penetration wiring 14 is formed in the through-hole V. To be more specific, by supplying electric power from the copper foil 2001 on the base substrate 2000, electrolytic plating is performed on the through-hole V of the glass substrate 2010 to form the first penetration conductor layer 2013. Otherwise, a seed layer may be formed on the surface of the glass substrate 2010 or an inner surface of the through-hole V by sputtering or the like, and the penetration conductor layer may be formed by using a known method such as fill plating, conformal plating, or a printing filling method of a conductive paste. In a case where there is unnecessary plating growth on the surface of the glass substrate 2010, an unnecessary part is removed by polishing, CMP, wet etching (etchback), or dry etching.

As shown in FIG. 16D, the base substrate 2000 is peeled off from the glass substrate 2010. In this case, the base substrate 2000 may be mechanically removed by grinding or the like, or may be chemically removed by etching or the like.

As shown in FIG. 16E, a bottom surface conductor layer 2011b which becomes the bottom surface wiring 11b and a top surface conductor layer 2011t which becomes the top surface wiring 11t are formed on the glass substrate 2010. To be more specific, a seed layer (not shown) is provided on the entire surface of the glass substrate 2010, and patterned photoresist is formed on the seed layer. A copper layer is formed on the seed layer in an opening portion of the photoresist by electrolytic plating. The photoresist and the seed layer are removed by wet etching or dry etching. Consequently, the bottom surface conductor layer 2011b and the top surface conductor layer 2011t patterned in an arbitrary shape are formed. In this case, the bottom surface conductor layer 2011b and the top surface conductor layer 2011t may be formed one by one, or may be formed simultaneously.

As shown in FIG. 16F, an insulating layer 2022 serving as the insulating body 22 is provided on a top surface and a bottom surface of the glass substrate 2010 to cover the conductor layer. In this case, the insulating layer 2022 on the bottom surface side and the insulating layer 2022 on the top surface side may be formed one by one, or may be formed simultaneously. Thereafter, a hole 2022a is formed in the bottom surface conductor layer 2011b of the insulating layer 2022 on the bottom surface side by photolithography or laser processing.

As shown in FIG. 16G, a first external electrode conductor layer 2121 which becomes the first external electrode 121 is provided on the insulating layer 2022 on the bottom surface side. In this case, the first external electrode conductor layer 2121 is connected to the bottom surface conductor layer 2011b via the hole 2022a. To be more specific, a Pd catalyst (not shown) is provided on the insulating layer 2022 on the bottom surface side, and an Ni/Au plated layer is formed by electroless plating. Patterned photoresist is formed on the plating layer. A plating layer in an opening portion of the photoresist is removed by wet etching or dry etching. Consequently, the first external electrode conductor layer 2121 patterned in an arbitrary shape is formed. Alternatively, a seed layer (not shown) is provided on the insulating layer 2022 on the bottom surface side, and the patterned photoresist is formed on the seed layer. Next, the seed layer in the opening portion of the photoresist is removed by wet etching or dry etching. An Ni/Au plating layer may be formed on the remaining seed layer by electroless plating. Although not shown, a second external electrode conductor layer which becomes the second external electrode 122 is provided on the insulating layer 2022 on the bottom surface side.

Here, since the first external electrode conductor layer 2121 is formed to conform to a shape of an upper surface of the insulating layer 2022 on the bottom surface side, an upper surface of the first external electrode conductor layer 2121 has a recess in a region overlapping the hole 2022a. Note that the first external electrode conductor layer 2121 may be formed to have a flat upper surface.

As shown in FIG. 16H, division into individual components is performed along the cutting line C. Consequently, as shown in FIG. 14, the inductor component 11 is manufactured.

### 2. Modification Examples

### First Modification Example

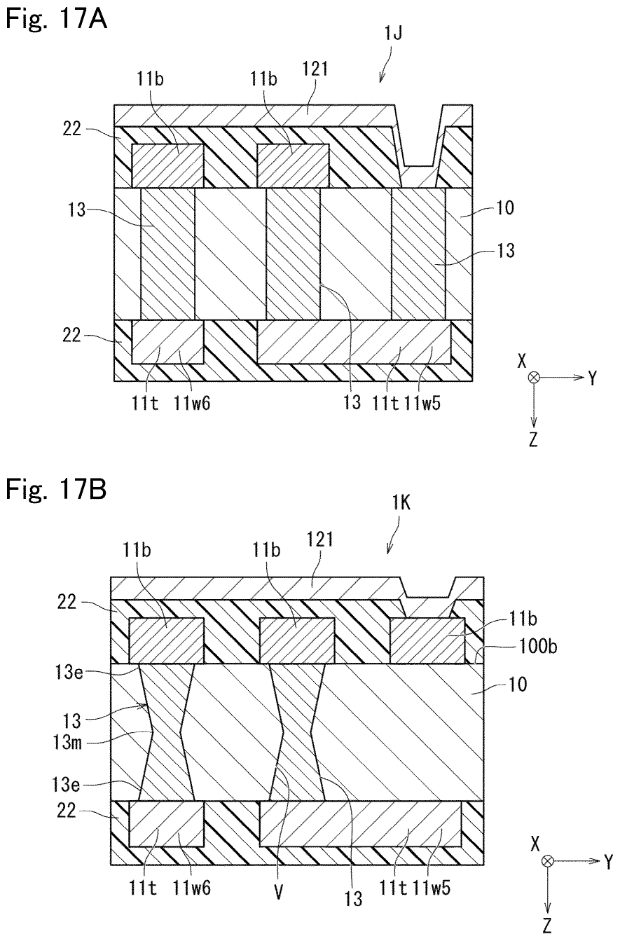

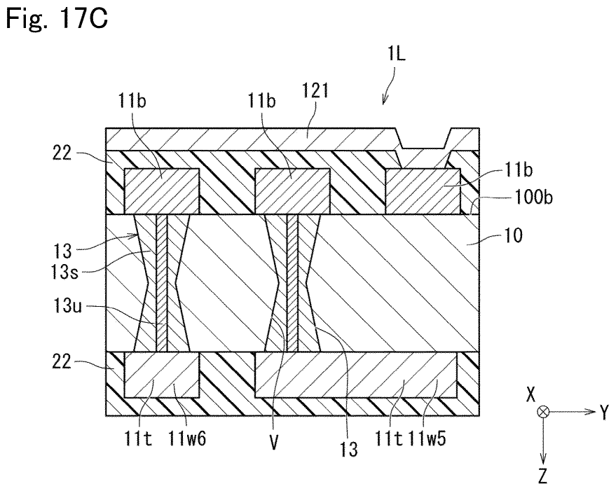

FIG. 17A is a view showing a first modification example of the inductor component, and the view corresponds to the cross section taken along line XIV-XIV in FIG. 13. As shown in FIG. 17A, in an inductor component 1J of the first modification example, the first external electrode 121 is not connected to the bottom surface wiring 11b but is connected to the first penetration wiring 13. That is, a first end portion of the corresponding first penetration wiring 13 is connected to the first external electrode 121, and a second end portion of the corresponding first penetration wiring 13 is connected to the fifth wide coil wiring 11w5. This enables the coil to be easily connected to the first external electrode 121 even when the number of turns of the coil is changed. Similarly, the second external electrode 122 may be connected to the second penetration wiring 14, instead of the bottom surface wiring 11b.

### Second Modification Example

FIG. 17B is a view showing a second modification example of the inductor component, and the view corresponds to the cross section taken along line XIV-XIV in FIG. 13. As shown in FIG. 17B, in an inductor component 1K of the second modification example, the first penetration wiring 13 extends in a direction orthogonal to the bottom surface wiring 11b, and a cross-sectional area of each of both end portions 13e of the first penetration wiring 13 in an extending direction thereof is larger than a cross-sectional area of a central portion 13m of the first penetration wiring 13 in the extending direction. That is, in a cross section of the first penetration wiring 13 in the extending direction, a width of the first penetration wiring 13 in a direction orthogonal to the extending direction continuously increases from the central portion 13m toward both the end portions 13e.

This enables the cross-sectional area of the end portion 13e of the first penetration wiring 13 to be increased, so that the connectivity between the first penetration wiring 13 and at least one of the bottom surface wiring 11b and the top surface wiring 11t can be improved. In addition, when the through-hole V is formed as a hole portion in the element body 10, the through-hole V is filled with a conductive material by fill plating or the like, and the first penetration wiring 13 is formed in the through-hole V, it is easy to fill the through-hole V on an opening side with the conductive material. Since the cross-sectional area of the end portion 13e of the first penetration wiring 13 is large, and the cross-sectional area of the central portion 13m of the first penetration wiring 13 is small, the first penetration wiring 13 is easily formed.

Note that the cross-sectional area of one end portion 13e of the first penetration wiring 13 may be larger than the cross-sectional area of the central portion 13m of the first penetration wiring 13. Similarly, the cross-sectional area of at least one end portion of the second penetration wiring 14 may be larger than the cross-sectional area of the central portion 13m of the first penetration wiring 13.

### Third Modification Example

FIG. 17C is a view showing third modification example of the inductor component, and the view corresponds to the cross section taken along line XIV-XIV in FIG. 13. As shown in FIG. 17C, in an inductor component 1L of the third modification example, the first penetration wiring 13 includes a conductive layer 13s positioned on an outer circumferential side thereof when viewed from an extending direction of the first penetration wiring 13, and a non-conductive layer 13u positioned inside the conductive layer 13s. This prevents the Q value from being reduced by providing the conductive layer 13s on the outer circumferential side since a current mainly flows in a surface of the first penetration wiring 13 due to a skin effect in the case of use in a high frequency band. In addition, by providing the non-conductive layer 13u inside, stress can be alleviated, and manufacturing costs can be reduced by using no conductor.

An example of a method of forming the conductive layer 13s and the non-conductive layer 13u will be described. A seed layer is provided on the inner surface of the through-hole V of the element body 10 by sputtering or electroless plating. A plating layer is formed on the seed layer by electrolytic plating. In this manner, for example, a plurality of conductive layers 13s of Ti/Cu/electrolytic Cu, Pd/electroless Cu/electrolytic Cu, or the like can be formed on the first penetration wiring 13 on the outer circumferential side thereof. Thereafter, the inside of the conductive layer 13s is sealed with a resin by printing, hot pressing, or the like to form the non-conductive layer 13u made of a resin. In this manner, stress can be alleviated by the non-conductive layer 13u inside the first penetration wiring 13 while a current flows in the surface (the conductive layer 13s) of the first penetration wiring 13.

Similarly, the second penetration wiring 14 may include a conductive layer positioned on an outer circumferential side thereof when viewed from an extending direction of the second penetration wiring 14, and a non-conductive layer positioned inside the conductive layer.

Note that the present disclosure is not limited to the embodiments described above, and can be modified in design without departing from the gist of the present disclosure. For example, the individual characteristic points of the first to sixth embodiments may be variously combined.

In the embodiments, the plurality of bottom surface wirings and the plurality of top surface wirings include two or more wide coil wirings, but may include at least one wide coil wiring.

In the third embodiment, the thickness of the third wide coil wiring is relatively thin, but in a case where the coil includes other wide coil wirings such as the first wide coil wiring, the second wide coil wiring, and the fourth wide coil wiring, the thicknesses of the other wide coil wirings may be relatively thin.

In the fifth embodiment, the bottom surface wiring positioned closest to the first end surface side of the element body is not the wide coil wiring, and the top surface wiring positioned closest to the first end surface side of the element body is the wide coil wiring. However, the bottom surface wiring positioned closest to the first end surface side of the element body may be the wide coil wiring, and the top surface wiring positioned closest to the first end surface side of the element body may not be the wide coil wiring. In this case, in the first penetration wiring positioned closest to the first end surface side of the element body, the area of the end surface on the bottom surface wiring side may be larger than the area of the end surface on the top surface wiring side. The same applies to the second penetration wiring positioned closest to the second end surface side of the element body.

In the sixth embodiment, the plurality of top surface wirings include only the wide coil wirings, but the plurality of bottom surface wirings may include only the wide coil wirings. In this case, the plurality of top surface wirings may not include the wide coil wiring.

The present disclosure includes the following aspects.

<1> An inductor component including an element body having a first principal surface and a second principal surface opposite to each other; a coil that is provided in the element body and is wound in a spiral shape along an axis; and a first external electrode and a second external electrode that are provided on the element body and are electrically connected to the coil. The axis of the coil is disposed parallel to the first principal surface. The coil includes a plurality of first coil wirings which are provided on the first principal surface side with respect to the axis and are arranged along the axis on a plane parallel to the first principal surface. A plurality of second coil wirings which are provided on the second principal surface side with respect to the axis and are arranged along the axis on a plane parallel to the second principal surface. A plurality of first penetration wirings which extend from the respective first coil wirings toward the respective second coil wirings and are arranged along the axis, and a plurality of second penetration wirings which extend from the respective first coil wirings toward the respective second coil wirings, are provided on a side opposite to the respective first penetration wirings with respect to the axis, and are arranged along the axis. Each of the first coil wirings, each of the first penetration wirings, each of the second coil wirings, and each of the second penetration wirings form at least a part of the spiral shape by being connected in this order. Also, at least one of two both-end first coil wirings positioned at both ends in the axial direction of the plurality of first coil wirings and two both-end second coil wirings positioned at both ends in the axial direction of the plurality of second coil wirings is a wide coil wiring. In addition, a maximum width of the wide coil wiring in the axial direction is larger than a maximum width of at least one coil wiring in the axial direction of inner coil wirings excluding the both-end first coil wirings and the both-end second coil wirings of the plurality of first coil wirings and the plurality of second coil wirings.

<2> The inductor component according to <1>, in which the maximum width of the wide coil wiring in the axial direction is larger than a maximum width of all the inner coil wirings in the axial direction.

<3> The inductor component according to <1> or <2>, in which the first external electrode is provided on the first principal surface of the element body, and the wide coil wiring is included only in the plurality of first coil wirings.

<4> The inductor component according to <1> or <2>, in which the first external electrode is provided on the first principal surface of the element body, and the wide coil wiring is included only in the plurality of second coil wirings.

<5> The inductor component according to any one of <1> to <4>, in which a width of the wide coil wiring in the axial direction is not constant in a direction orthogonal to the axial direction.

<6> The inductor component according to any one of <1> to <5>, in which the first external electrode has a via part connected to the coil, the via part is connected to the wide coil wiring, and an area of a contact surface of the wide coil wiring with the via part is larger than an area of a contact surface of at least one coil wiring of the inner coil wirings with the corresponding first penetration wiring.

<7> The inductor component according to any one of <1> to <6>, in which the first external electrode has a plurality of via parts connected to the coil, and the plurality of via parts are connected to the wide coil wiring.

<8> The inductor component according to any one of <1> to <7>, in which a thickness of the wide coil wiring is smaller than a thickness of at least one coil wiring of the inner coil wirings.

<9> The inductor component according to any one of <1> to <8>, in which the wide coil wiring is included in only one group of a first group including the plurality of first coil wirings and a second group including the plurality of second coil wirings, and a thickness of all the coil wirings in the group including the wide coil wiring from the first group and the second group is smaller than a thickness of all the coil wirings in the group without including the wide coil wiring.

<10> The inductor component according to any one of <1> to <9>, in which one set of the plurality of first coil wirings and the plurality of second coil wirings includes only the wide coil wirings.

<11> The inductor component according to any one of <1> to <10>, in which, when viewed in a direction orthogonal to the first principal surface, a ratio of a total area of the plurality of first coil wirings to an area of the first principal surface is 50% or more and 95% or less (i.e., from 50% to 95%), and a ratio of a total area of the plurality of second coil wirings to the area of the first principal surface is 50% or more and 95% or less (i.e., from 50% to 95%).

<12> The inductor component according to any one of <1> to <11>, in which the wide coil wiring is included in at least one group of a first group including the plurality of first coil wirings and a second group including the plurality of second coil wirings. Also, when viewed in a direction orthogonal to the first principal surface, a ratio of a total area of all the coil wirings in a group including the wide coil wiring from the first group and the second group to an area of the first principal surface is 65% or more.

<13> The inductor component according to any one of <1> to <12>, in which the wide coil wiring is included in only one group of a first group including the plurality of first coil wirings and a second group including the plurality of second coil wirings. Also, when viewed in a direction orthogonal to the first principal surface, a ratio of a total area of all the coil wirings in a group including the wide coil wiring from the first group and the second group to an area of the first principal surface is higher than a ratio of a total area of all the coil wirings in a group without including the wide coil wiring to the area of the first principal surface.

<14> The inductor component according to any one of <1> to <9>, in which the wide coil wiring is included in both of the plurality of first coil wirings and the plurality of second coil wirings.

<15> The inductor component according to any one of <1> to <14>, in which, when viewed in a direction orthogonal to the first principal surface, the wide coil wiring has a corner portion on an outer side of the coil in a radial direction, that is, on a center side of the element body in the axial direction, and the wide coil wiring is connected to one of the first penetration wirings at the corner portion.

<16> The inductor component according to any one of <1> to <15>, in which, when viewed in a direction orthogonal to the first principal surface, an external shape of the wide coil wiring includes a part conforming to an external shape of the element body, and a part of the first coil wirings and the second coil wirings which conforms to an external shape of a coil wiring adjacent to the wide coil wiring in the axial direction on the same plane.

<17> The inductor component according to any one of <1> to <16>, in which the wide coil wiring is connected to one of the first penetration wirings, and an area of a contact surface of the wide coil wiring with the corresponding first penetration wiring is larger than an area of a contact surface of at least one coil wiring of the inner coil wirings with the corresponding first penetration wiring.

<18> The inductor component according to any one of <1> to <17>, in which a first end surface of the first penetration wiring in an extending direction is connected to one of the corresponding first coil wiring and the corresponding second coil wiring, and a second end surface of the first penetration wiring in the extending direction is connected to the other of the corresponding first coil wiring and the corresponding second coil wiring. Also, the wide coil wiring is connected to at least the first end surface, of the first end surface and the second end surface, and an area of the first end surface is larger than an area of the second end surface.

What is claimed is:

1. An inductor component including:
an element body having a first principal surface and a second principal surface opposite to each other;
a coil that is in the element body and is wound in a spiral shape along an axis; and
a first external electrode and a second external electrode that are on the element body and are electrically connected to the coil, wherein
the axis of the coil is parallel to the first principal surface,
the coil includes
a plurality of first coil wirings which are on the first principal surface side with respect to the axis and are arranged along the axis on a plane parallel to the first principal surface,
a plurality of second coil wirings which are on the second principal surface side with respect to the axis and are arranged along the axis on a plane parallel to the second principal surface,
a plurality of first penetration wirings which extend from the respective first coil wirings toward the respective second coil wirings and are arranged along the axis, and
a plurality of second penetration wirings which extend from the respective first coil wirings toward the respective second coil wirings, are on a side opposite to the respective first penetration wirings with respect to the axis, and are arranged along the axis,
each of the first coil wirings, each of the first penetration wirings, each of the second coil wirings, and each of the second penetration wirings configure at least a part of the spiral shape by being connected in this order,
at least one of two both-end first coil wirings at both ends in the axial direction of the plurality of first coil wirings and two both-end second coil wirings at both ends in the axial direction of the plurality of second coil wirings is a wide coil wiring, and
a maximum width of the wide coil wiring in the axial direction is larger than a maximum width of at least one coil wiring in the axial direction of inner coil wirings excluding the both-end first coil wirings and the both-end second coil wirings of the plurality of first coil wirings and the plurality of second coil wirings.

2. The inductor component according to claim 1, wherein
the maximum width of the wide coil wiring in the axial direction is larger than a maximum width of all the inner coil wirings in the axial direction.

3. The inductor component according to claim 1, wherein
the first external electrode is on the first principal surface of the element body, and
the wide coil wiring is only in the plurality of first coil wirings.

4. The inductor component according to claim 1, wherein
the first external electrode is on the first principal surface of the element body, and
the wide coil wiring is only in the plurality of second coil wirings.

5. The inductor component according to claim 1, wherein
a width of the wide coil wiring in the axial direction is not constant in a direction orthogonal to the axial direction.

6. The inductor component according to claim 1, wherein
the first external electrode has a via part connected to the coil,
the via part is connected to the wide coil wiring, and
an area of a contact surface of the wide coil wiring with the via part is larger than an area of a contact surface of at least one coil wiring of the inner coil wirings with the corresponding first penetration wiring.

7. The inductor component according to claim 1, wherein
the first external electrode has a plurality of via parts connected to the coil, and
the plurality of via parts are connected to the wide coil wiring.

8. The inductor component according to claim 1, wherein
a thickness of the wide coil wiring is smaller than a thickness of at least one coil wiring of the inner coil wirings.

9. The inductor component according to claim 1, wherein
the wide coil wiring is in only one group of a first group including the plurality of first coil wirings and a second group including the plurality of second coil wirings, and
a thickness of all the coil wirings in the group including the wide coil wiring from the first group and the second group is smaller than a thickness of all the coil wirings in the group without including the wide coil wiring.

10. The inductor component according to claim 1, wherein
either the plurality of first coil wirings or the plurality of second coil wirings include only the wide coil wirings.

11. The inductor component according to claim 1, wherein
when viewed in a direction orthogonal to the first principal surface,
a ratio of a total area of the plurality of first coil wirings to an area of the first principal surface is from 50% to 95%, and
a ratio of a total area of the plurality of second coil wirings to the area of the first principal surface is from 50% to 95%.

12. The inductor component according to claim 1, wherein
the wide coil wiring is in at least one group of a first group including the plurality of first coil wirings and a second group including the plurality of second coil wirings, and
when viewed in a direction orthogonal to the first principal surface, a ratio of a total area of all the coil wirings in a group including the wide coil wiring from the first group and the second group to an area of the first principal surface is 65% or more.

13. The inductor component according to claim 1, wherein
the wide coil wiring is in only one group of a first group including the plurality of first coil wirings and a second group including the plurality of second coil wirings, and
when viewed in a direction orthogonal to the first principal surface, a ratio of a total area of all the coil wirings in a group including the wide coil wiring from the first group and the second group to an area of the first principal surface is higher than a ratio of a total area of all the coil wirings in a group without including the wide coil wiring to the area of the first principal surface.

14. The inductor component according to claim 1, wherein
the wide coil wiring is in both of the plurality of first coil wirings and the plurality of second coil wirings.

15. The inductor component according to claim 1, wherein
when viewed in a direction orthogonal to the first principal surface,
the wide coil wiring has a corner portion on an outer side of the coil in a radial direction, that is, on a center side of the element body in the axial direction, and
the wide coil wiring is connected to one of the first penetration wirings at the corner portion.

16. The inductor component according to claim 1, wherein
when viewed in a direction orthogonal to the first principal surface, an external shape of the wide coil wiring includes a part conforming to an external shape of the element body, and a part of the first coil wirings and the second coil wirings which conforms to an external shape of a coil wiring adjacent to the wide coil wiring in the axial direction on the same plane.

17. The inductor component according to claim 1, wherein
the wide coil wiring is connected to one of the first penetration wirings, and
an area of a contact surface of the wide coil wiring with the corresponding first penetration wiring is larger than an area of a contact surface of at least one coil wiring of the inner coil wirings with the corresponding first penetration wiring.

18. The inductor component according to claim 1, wherein
a first end surface of the first penetration wiring in an extending direction is connected to one of the corresponding first coil wiring and the corresponding second coil wiring,
a second end surface of the first penetration wiring in the extending direction is connected to the other of the corresponding first coil wiring and the corresponding second coil wiring,
the wide coil wiring is connected to at least the first end surface, of the first end surface and the second end surface, and
an area of the first end surface is larger than an area of the second end surface.

19. The inductor component according to claim 2, wherein
the first external electrode is on the first principal surface of the element body, and
the wide coil wiring is only in the plurality of first coil wirings.

20. The inductor component according to claim 2, wherein
the first external electrode is on the first principal surface of the element body, and
the wide coil wiring is only in the plurality of second coil wirings.
